(19) United States
(12) Patent Application Publication
(10) Pub. No.: US 2006/0238004 A1
(43) Pub. Date: Oct. 26, 2006

(54) Modular seating system

(76) Inventors: John P. Conner, Grandville, MI (US); Steven E. Finney, Allendale, MI (US); Richard N. Roslund JR., Jenison, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/401,768

(22) Filed: Apr. 11, 2006

Related U.S. Application Data
(60) Provisional application No. 60/670,444, filed on Apr. 12, 2005.

(51) Int. Cl. B60N 2/42

(52) U.S. Cl. 297/216.14

(57) ABSTRACT

A modular seating system and installation method includes a plurality of seat assemblies fixedly arranged in rows in a seating facility. The seat assemblies have common support assemblies that support a respective seat portion and back rest of the seat assembly. An arm is adjustably mounted to each of the support assemblies, and is adjusted relative to the respective support assembly to provide a desired effective width of each of the seat assemblies. The arm is adjusted to a different position relative to the support assembly for at least some of the seat assemblies to provide the desired effective width and spacing of seat assemblies along the rows of seat assemblies. The fold angle of the seats and/or the tilt angle of the back rests may also or otherwise be adjustable depending on the particular application of the seat assemblies.

### CROSS REFERENCE TO RELATED APPLICATION

The present application claims the benefit of U.S. provisional application Ser. No. 60/670,444, filed Apr. 12, 2005 (Attorney Docket IRW02 P-321), which is hereby incorporated herein by reference in its entirety.

### FIELD OF THE INVENTION

The present invention relates to fixed seats and seating arrangements and, more particularly, to fixed seats arranged in rows at an auditorium or theater or the like.

### BACKGROUND OF THE INVENTION

Typically, seats or chairs are fixedly arranged in auditoriums or theaters or the like in a plurality of rows, with the rows sometimes being curved or arcuate so that each chair is oriented or slightly angled so as to be directed generally toward the center region of the stage or screen or the like. The chairs in adjacent rows are often staggered, so that a chair in one row is not directly behind another chair in the row that is immediately in front of the one row, in order to enhance the view for the people sitting in the chairs. However, in order to arrange the chairs in multiple rows in this manner, multiple chair sizes or chair widths are implemented and arranged so that the final installed chairs are in the planned or desired location and orientation. The chairs thus are arranged so that the end chairs of sequential or adjacent rows are different sizes and/or other chairs along the rows are different sizes so that the chairs (or center lines of the chairs) of one row are staggered or not aligned with chairs (or center lines of chairs) in the row immediately forward or rearward of the particular row. The selected chair sizes for at least some of the chairs thus may be different to provide such an arrangement.

The chair sizes are selected and arranged on the layout so that the chairs, when eventually installed, will provide optimum viewing and proper spacing of the chairs along each row of chairs. In order to position the chairs in this manner, there is a great deal of careful planning involved, where a layout is generated of the seating facility and the appropriate chair size is selected or targeted for each seating location along each row. For example, a typical seating arrangement may include chairs having widths ranging from about 19 inches to about 23 inches (such as, for example, 19 inch wide chairs, 21 inch wide chairs and/or 23 inch wide chairs). For each size of chair, the chair typically includes several size specific components to properly assemble and install that specific sized chair.

The chairs positioned along each row thus may have multiple widths, with each chair of one width having different components (such as different back or seat mounting brackets, seat cushions, back rests, seat supports or bases and the like) than the chairs of another width. Also, the mounting brackets or bases of the chairs must be irregularly spaced to accommodate the different width of the chairs in each row (and to ensure that both ends of each row generally align with the respective aisles). Thus, prior to the installation process, the seating layout is carefully planned and designed and the appropriate components (for example, the appropriate number of each of the different back rests, seats, frames, brackets and the like) are ordered and manufactured and shipped to the seating facility. Once a layout is generated, the appropriate chairs and components are ordered/manufactured/shipped to the seating facility along with the installation plan or layout, so that the chairs may be installed at the seating facility or theater or auditorium or the like. At the seating facility, careful planning and installation is required in order to install the appropriate chairs (and associated components) at the appropriate or selected or designed location.

However, there are often many chairs installed in the wrong location (as compared to the planned layout), such as, for example, a 21 inch wide chair (with a 21 inch wide seat cushion and back rest and corresponding frame) being installed at a location targeted for a 19 inch wide chair. Such errors may be due to operator error in reading and/or understanding the printed layout or plans, and result in the rows of chairs not being optimally installed as planned. Also, because some chairs are installed at different or incorrect locations along a row, other chairs along the row may be adversely affected. This often results in revisions in the field to adjust the seating plan and to install different chairs and/or chair components (such as different width chairs and the associated different components) so that the rows of chairs may be completed and may properly terminate at or near the aisles. Such field or installation revisions to the planned layout results in a different number of chairs of any given size or width being installed than what was set forth in the planned layout.

Additionally, there are often dimensional discrepancies between the original building or facility plan and the final construction of the building or facility, often resulting in further onsite revisions to the seating layout, which is typically designed based on the building plan dimensions. Thus, due to the typical changes in the chair installation as compared to the original plans, there are often extra parts or components of one or more of the different size/width chairs and a shortage of other parts or components after the installation is complete or nearly completed. Even though the chair manufacturer carefully plans the layout and the chairs and components are inadvertently or improperly installed in a manner that is different than the planned layout, the manufacturer often is contacted by the installers or by the facility or contractor to correct the problem and provide the additional parts for which there is a shortage, which results in additional costs to the manufacturer/supplier of the chairs.

Therefore, there is a need in the art for chairs or seat assemblies and seating arrangements for theaters and auditoriums and the like that overcome the shortcomings of the prior art.

### SUMMARY OF THE INVENTION

The present invention provides a modular chair or seat assembly and adjustable seating arrangement and installation method that includes a plurality of seat assemblies or chairs that are arrangable in rows and that are adjustable to accommodate the desired location and spacing and orientation of the seat assemblies. The seat assemblies or chairs of the present invention include common support mechanisms or assemblies, and include adjustable arms or arm assemblies that are laterally adjustable to provide the desired spacing between the seat assemblies or chairs of each of the multiple rows at the seating facility. The seat assemblies or chairs of the present invention may be readily installed, with little or no customization of the seat assemblies and seat components for the seat assemblies with different width specifications in the planned layout or seating arrangement.

According to an aspect of the present invention, a method of fixedly installing a plurality of seat assemblies along multiple rows at a seating facility includes providing a plurality of common support assemblies, each having a base portion, a seat support portion and a back rest support portion. A plurality of first and second seat portions and a plurality of first and second back rests are provided. The first seat portions have a different width than the second seat portions and the first back rests have a different width than the second back rests. The base portions are mounted at a support structure of the seating facility, and are arranged in multiple rows at the support structure and are spaced from one another along the rows. The seat support portions and the back rest support portions are mounted to the base portions. The seat support portions are pivotable relative to the base portions to pivot the seat support portions between a lowered in-use position and an upper storage position. One of the first and second seat portions and one of the first and second back rests are selected for each of the support assemblies. The selected seat portions and back rests are attached to the seat support portions and the back rest support portions, respectively, of the support assemblies. An arm is mounted to each of the support assemblies, and a lateral position of at least some of the arms is adjusted relative to the support assemblies to adjust an effective width of at least some of the seat assemblies. The seat assemblies thus may have different sized or width back rests and seats attached thereto, and may have the lateral arm position adjusted accordingly so as to provide different width seat assemblies along the rows of seat assemblies, while providing common support assemblies for all of the seat assemblies.

Desirably, the seat assemblies may be assembled as individual units before installation at the seating facility, whereby the fully assembled seat assemblies may be installed at the appropriate locations at the seating facility. For example, the seat manufacturer may assemble the seat assemblies and ship the seat assemblies to the seating facility. The people installing the seat assemblies at the seating facility may then readily mount the base portions of the support assemblies to the appropriate support structure (such as the floor of the seating facility or a support beam at the seating facility or the like, or such as to a base portion or element fixedly attached to a support structure or floor of the seating facility) to install the fully assembled seat assemblies at the support structure. Optionally, the seat assemblies may be provided as fully assembled units that may be readily attached to respective base portions or mounting portions that are first installed at the appropriate locations at the seating facility. Optionally, however, the seat assemblies may be assembled at the seating facility as part of the installation process.

According to another aspect of the present invention, a seating system includes a plurality of seat assemblies that are arranged in rows of seat assemblies at a seating facility. Each of the seat assemblies includes a common support assembly and an arm adjustably mounted to a respective one of the common support assemblies. The common support assembly supports a respective seat portion and back rest. The arm is adjusted relative to the support assembly to provide a desired effective width of each of the seat assemblies. The arm is adjusted to a different position relative to the support assembly for at least some of the seat assemblies to provide the desired spacing of seat assemblies along the rows of seat assemblies. The seat assemblies may have different sized or width back rests and seat portions attached thereto to provide different width seat assemblies along the rows of seat assemblies.

According to another aspect of the present invention, a seat assembly for a seating facility includes a base portion or element that is fixedly securable at the seating facility. The seat assembly is adaptable for different seat sizes and orientations. The seat assembly includes a back rest support mounted to the base portion and a seat support pivotally mounted to the base portion. The seat support pivots through a fold angle between a raised orientation and a lowered orientation. The seat assembly is adjustable to adjust the fold angle of the seat support. The seat assembly includes a back rest mounted on the back rest support and a seat mounted on the seat support.

According to yet another aspect of the present invention, a seat assembly for a seating facility includes a base portion or element that is fixedly securable at the seating facility. The seat assembly is adaptable for different seat assembly sizes and orientations. The seat assembly includes a back rest support adjustably mounted to the base portion and a seat support pivotally mounted to the base portion. The back rest support is adjustable to adjust a tilt angle of the back rest support relative to the base portion. The seat assembly includes a back rest mounted on the back rest support and a seat cushion or seat portion mounted on the seat support.

According to another aspect of the present invention, a seat assembly for a seating facility includes a base portion or element that is fixedly securable at the seating facility. The seat assembly is adaptable for different seat assembly sizes and orientations. The seat assembly includes a back rest support mounted to the base portion, a seat support pivotally mounted to the base portion, and an arm support for supporting an arm of the seat assembly. The arm support is adjustably mounted to the back rest support to adjust an effective width of the seat assembly. The seat assembly includes a back rest mounted on the back rest support and a seat portion mounted on the seat support.

Therefore, the present invention provides a seat assembly and seating system and method of installing a plurality of seat assemblies for a fixed seating facility, such as a theater or auditorium or the like, where the chairs or seat assemblies may have common base portions and seat supports and back rest supports, and are adjustable or adaptable to adapt the seat assemblies for the particular application. The seat assemblies are adjustable to adjust the position and orientation of an arm rest of the seat assemblies and/or may be adjustable to adjust a tilt angle of the back rests of the seat assemblies and/or may be adjustable to adjust a fold angle of the seat portions of the seat assemblies. The seat assemblies thus may be adjustable to accommodate the planned layout of the rows of seat assemblies at the seating facility (and/or at other seating facilities), without customized components for each different sized or different width or different style seat assembly. The seat assemblies thus may be readily installed at a seating facility with reduced installation errors and enhanced field adjustability and, thus, an enhanced finished product at the seating facility.

These and other objects, advantages, purposes and features of the present invention will become apparent upon review of the following specification in conjunction with the drawings.

### BRIEF DESCRIPTION OF THE DRAWINGS

FIG. 1 is a perspective view of a modular seat assembly in accordance with the present invention;

FIG. 2A is a side elevation of the modular seat assembly of FIG. 1;

FIG. 2B is a side elevation similar to FIG. 2A, with the seat folded up;

FIG. 3 is a front elevation of a modular seat assembly in accordance with the present invention;

FIG. 4 is a sectional view of the modular seat assembly of FIG. 3;

FIG. 5 is an exploded perspective view of the modular seat assembly of the present invention;

FIG. 6 is a perspective view of a plurality of rows of seat assemblies arranged at a seating facility in accordance with the present invention;

FIG. 7 is an exploded perspective view of the support assembly of the modular seat assembly of the present invention;

FIG. 8 is an exploded perspective view of the pivot assembly of the modular seat assembly of the present invention;

FIG. 9 is a perspective view of a portion of the pivot assembly of FIG. 8;

FIG. 10 is a perspective view of the support assembly of the modular seat assembly of the present invention;

FIG. 11 is a front elevation of the support assembly of the modular seat assembly of the present invention;

FIG. 12 is a perspective view of a lower pivot element of the pivot assembly of the modular seat assembly;

FIG. 13 is a perspective view of the pivot assembly of the modular seat assembly of the present invention, with the seat support element pivoted downward;

FIG. 14 is a sectional view of the pivot assembly of FIG. 13;

FIG. 15 is a perspective view of the pivot assembly of FIG. 13, with the seat support element pivoted upward;

FIG. 16 is a sectional view of the pivot assembly of FIG. 15;

FIG. 17 is a perspective view of the pivot assembly of FIG. 15, with the seat support element pivoted further upward;

FIG. 18 is a sectional view of the pivot assembly of FIG. 17;

FIG. 19 is a perspective view of the lower pivot element of FIG. 12, with a pivot limiting stop element attached thereto;

FIGS. 20 and 21 are sectional views of the pivot assembly with the pivot limiting stop element of FIG. 19, shown at different degrees of upward pivoting of the seat support element;

FIG. 22 is a perspective view of an adjustable arm support for the modular seat assembly of the present invention;

FIG. 23 is a perspective view of another adjustable arm support of the present invention;

FIG. 24 is a top plan view of an adjustable arm support of the present invention;

FIG. 25 is a sectional view of the adjustable arm support taken along the line XXV-XXV in FIG. 24;

FIG. 26 is a perspective view of various optional items suitable for the modular seat assembly of the present invention;

FIGS. 27-29 are perspective views of a pair of support assemblies and adjustable arm rests of the present invention;

FIG. 30 is an exploded perspective view of another modular seat assembly of the present invention;

FIG. 31 is an exploded perspective view of the modular seat assembly of FIG. 30;

FIG. 32 is a sectional view of the modular seat assembly of FIG. 30; and

FIG. 33 is an exploded perspective view of a portion of the support assembly, showing an angle indicator for indicating a selected angle of the seat back support relative to the base element of the support assembly.

### DESCRIPTION OF THE PREFERRED EMBODIMENTS

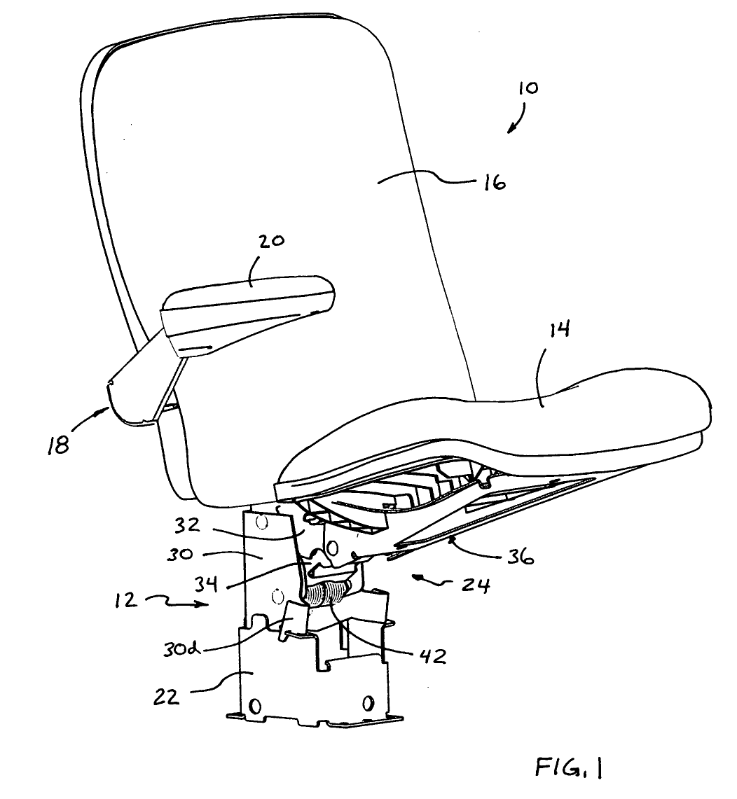

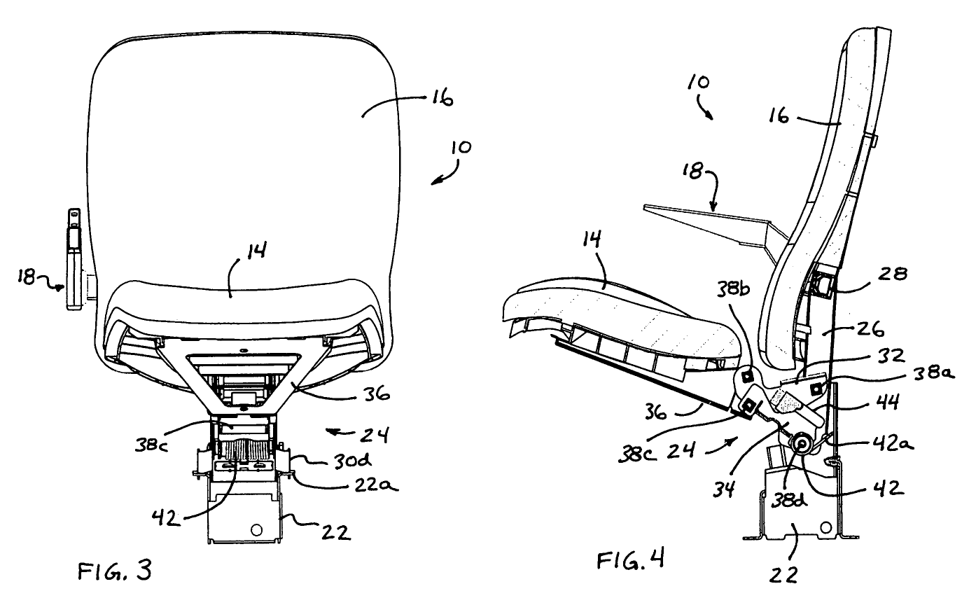

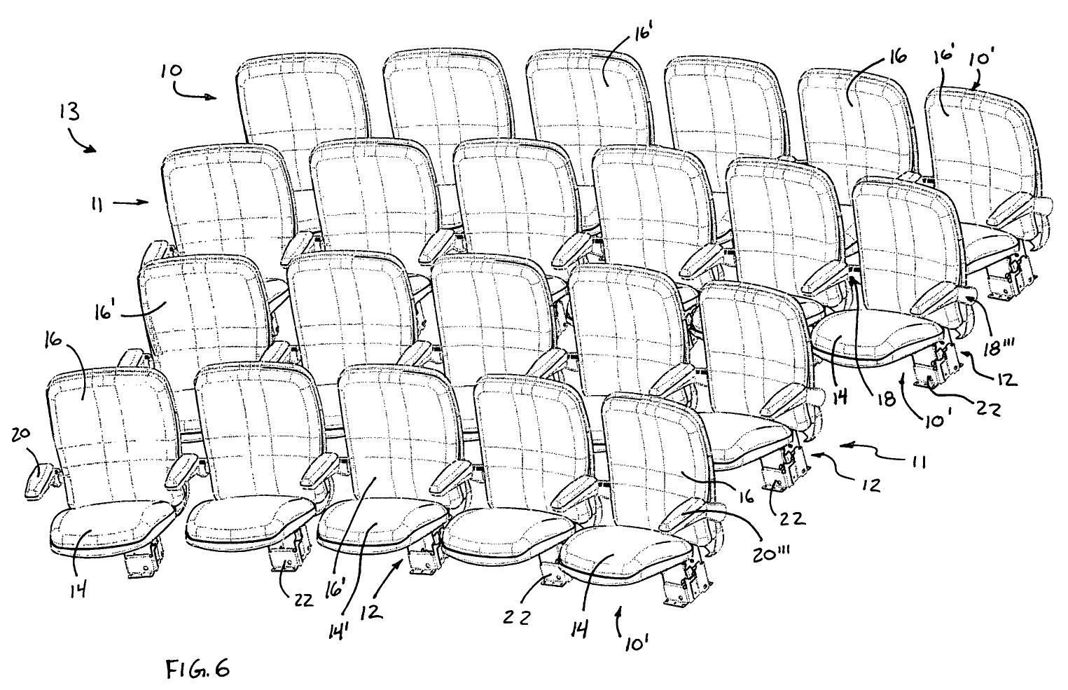

Referring now to the drawings and the illustrative embodiments depicted therein, a modular seat assembly or chair assembly 10 includes a support assembly 12 that supports a seat portion 14 and a back rest portion 16 and an adjustable arm support 18 (FIGS. 1-5). The support assembly 12 is a common or universal support assembly for various seat sizes and/or designs and supports the desired or appropriate seat portion 14 and back rest portion 16 to provide the appropriate seating arrangement when multiple seat assemblies are arranged and installed in multiple rows 11 at a seating facility 13, such as an auditorium or stadium or theater or the like (such as shown in FIG. 6). The adjustable arm support 18 supports an arm rest 20 and is laterally adjustable relative to the support assembly 12 to adjust the effective width of the seat assembly and to properly or appropriately position the arm rest 20 of the seat assembly between adjacent seat assemblies in the row, as discussed below. The seat portions and back rest portions of multiple seat assemblies of a given row of seat assemblies may have different widths for some seat assemblies (such as seat portions 14 and back rests 16 of one width and seat portions 14′ and back rests 16′ of another width, such as shown in FIG. 6) as compared to other seat assemblies along the row of seat assemblies. The seat support may be adjustable to adjust a fold angle of the seat portion 14 and/or a tilt angle of the back rest portion 16, as also discussed below.

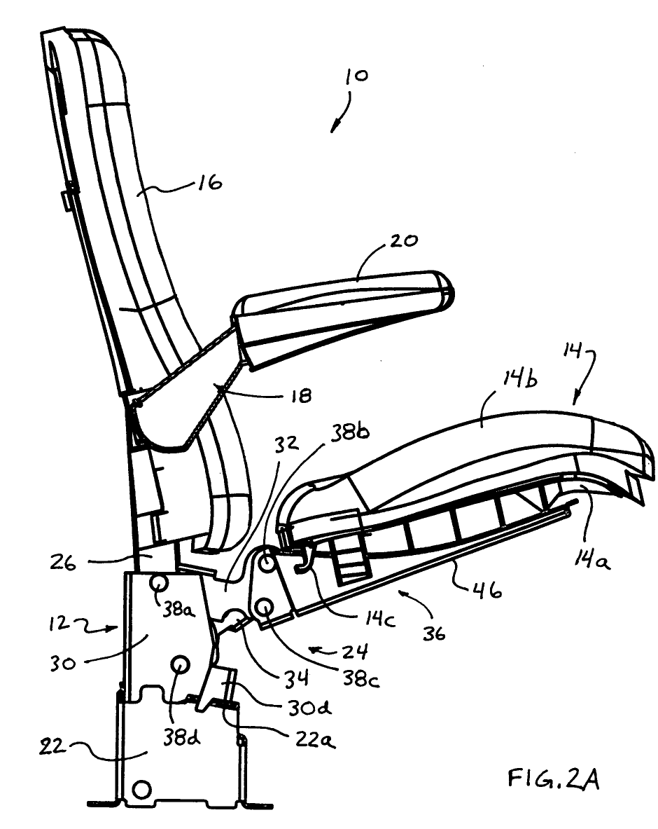

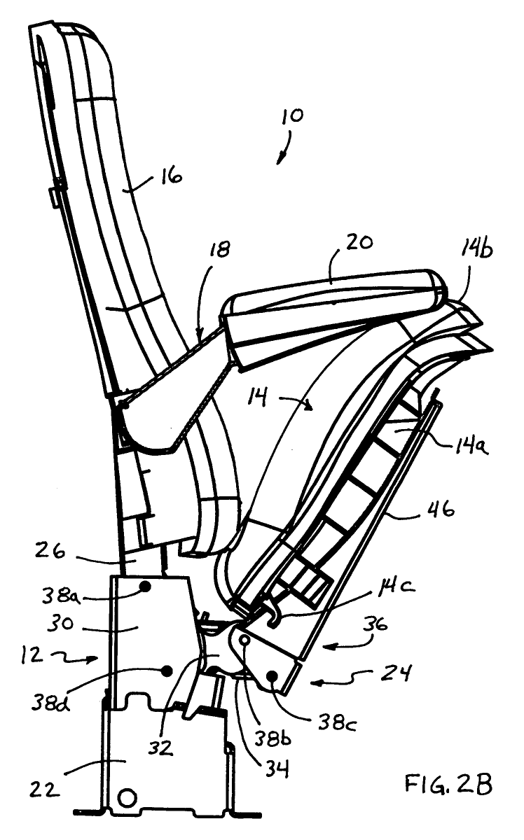

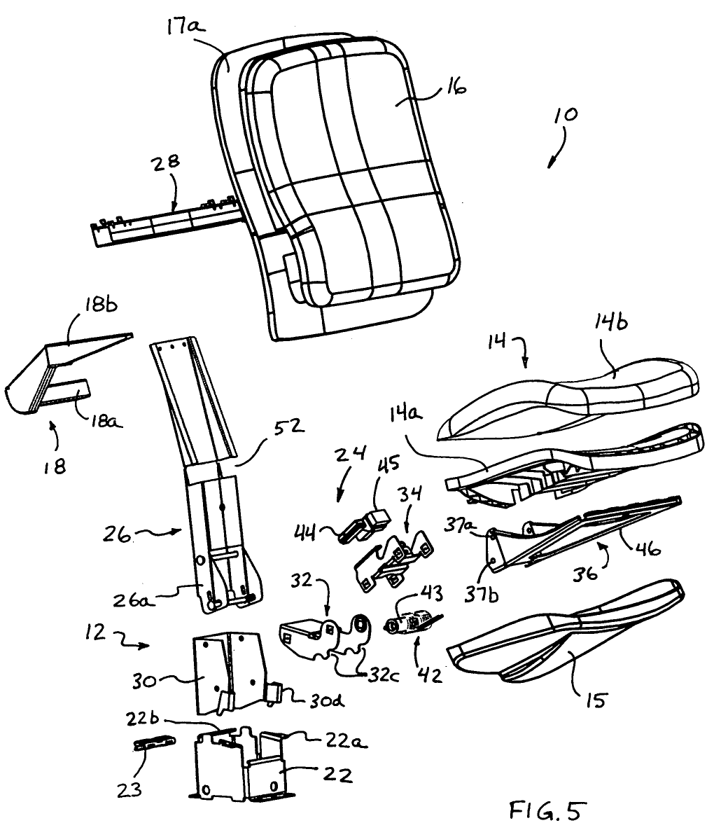

Support assembly 12 includes a base or base portion 22 and a seat support and pivot mechanism or assembly or seat lift mechanism or assembly 24 and a back rest support member 26 (FIGS. 2A, 2B, 4 and 5). The seat support and pivot mechanism 24 comprises a four component or four member pivot assembly and supports and pivots the seat portion 14, as discussed below. The back rest support member 26 supports the back rest portion 16 and may include or attach to a cross member or bar 28 (FIGS. 4 and 5) for attaching to the adjustable arm support 18, as also discussed below. The seat support and pivot mechanism 24 and back rest support member 26 may comprise common components for the seating assemblies of any given seating layout or arrangement and for different seating arrangements or applications, whereby the desired or appropriate seat portions and back rests and arm supports and arm rests may be attached to the seat support and pivot mechanism 24 and back rest support member 26, and the appropriate or desired base portion 22 may be selected for the desired or targeted or particular application.

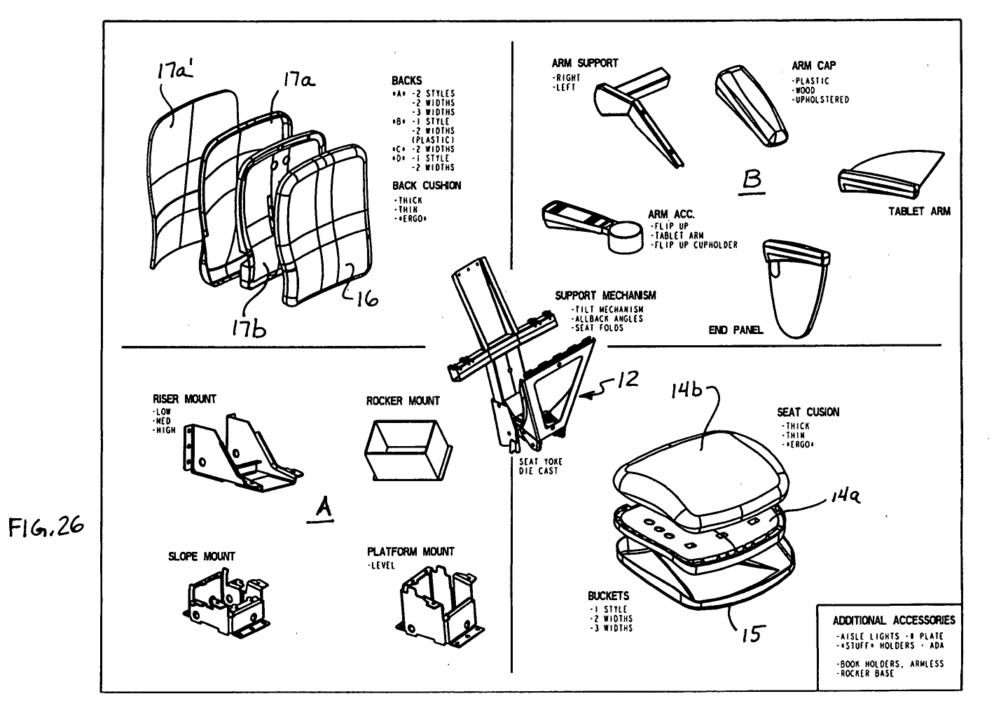

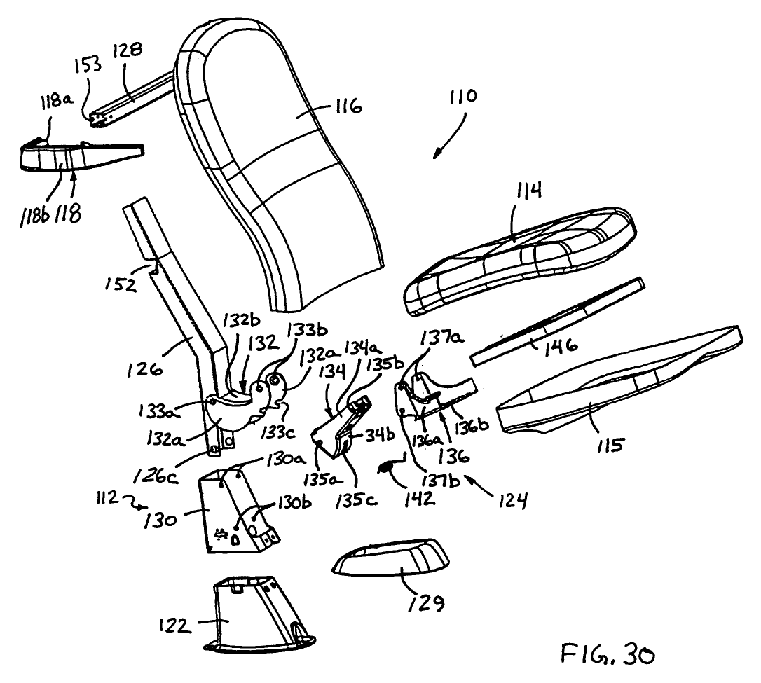

In the illustrated embodiment, base portion 22 comprises a floor mounted base or post for securing to a floor or support structure (such as via fasteners or bolts or the like securing a base plate to the floor of the seating facility). The seat support and pivot mechanism 24 may be bolted or otherwise attached to the base portion 22, such as via fasteners or bolts or the like, to secure the seat support and pivot mechanism 24 to the base portion 22 and in the desired location at the seating facility. Although shown as a floor mounted base portion, the seat assembly may be mounted to other support structures or the like via other types of base or mounting portions, such as a platform mount, a riser mount, a beam mount, a rocker mount, a riser rocker mount, a slope mount or a multi-slope mount or rocker (where the base portion may be adjusted to adjust an angle of the seat support and pivot mechanism relative to the support surface at which the base portion is mounted), such as, for example, base structures of the types shown at A in FIG. 26, without affecting the scope of the present invention. Optionally, a base cover may be positioned at the base or lower portion of the base portion 22 to cover the mounting plate and associated fasteners, in order to enhance the aesthetic appearance of the seat assembly when it is installed at the seating facility (such as, for example, the base cover 129 shown in FIG. 30).

Seat support and pivot assembly or mechanism 24 includes a base portion or member or element 30 that attaches to the base portion 22 and that receives or attaches to the back rest support member 26. Base element 30 supports an upper pivot link or member or element 32 and a lower pivot link or member or element 34, which are each pivotally attached to base element 30 at one end and to a seat support member or bracket or element 36 at the other end. The upper and lower pivot elements 32, 34 and seat support element 36 cooperate to define a mechanical linkage that pivots relative to the base element 30 to raise and lower the seat portion 14. The mechanical linkage provides for a range of adjustment of the seat portion 14 between a lowered position (as shown in FIGS. 1, 2A, 3 and 4) and a raised position (as shown in FIG. 2B), and provides for such adjustment with a reduced force required to raise the seat as compared to known single pivot axis type seat assemblies. The seat portion thus may pivot relative to the base element about more than one pivot axis, which provides reduced lowering forces to lower the seat portion to the lowered position, and which provides enhanced structural rigidity to the seat assembly when the seat portion is in its lowered position (via engagement of the upper pivot element with the lower pivot element or pivot axle of the lower pivot element when the seat portion is in its lowered position, as discussed below). Also, the linkage arrangement may limit or substantially preclude the front edge of the seat from rising above an unacceptable or undesirable height when in the upper or raised position, and may create a more compact envelope in the upper or raised position.

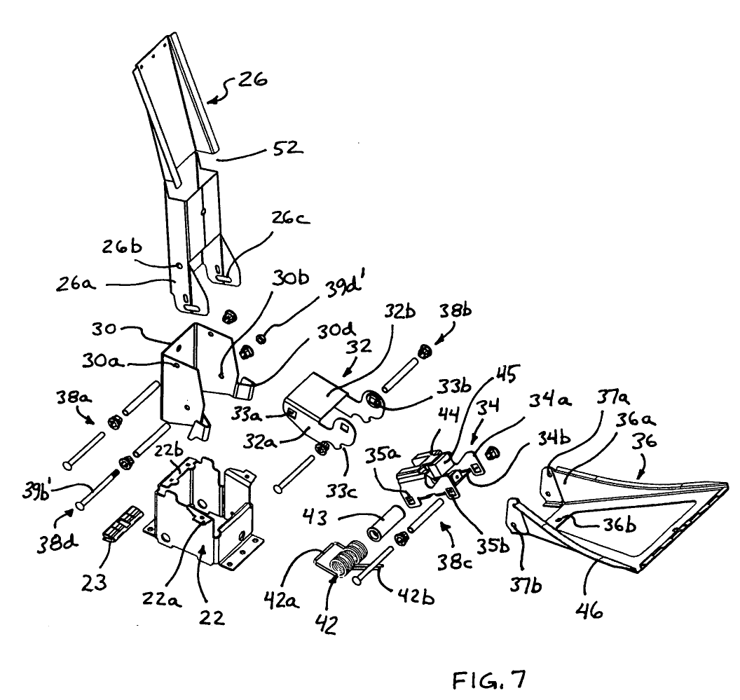

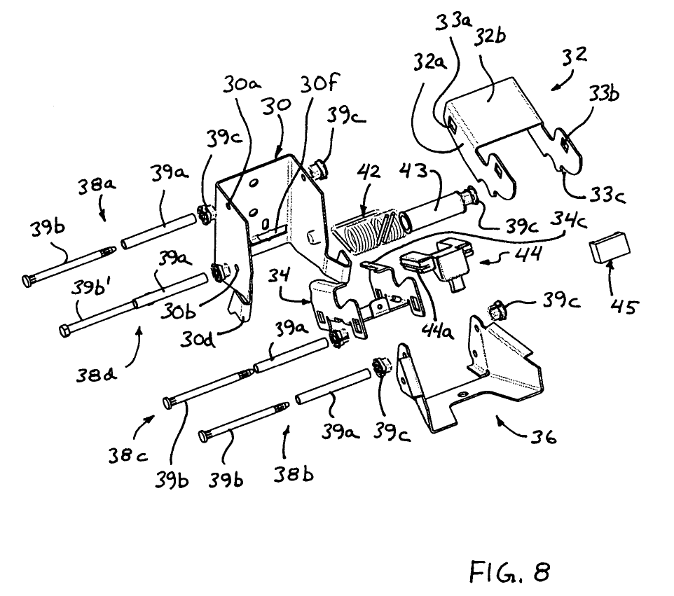

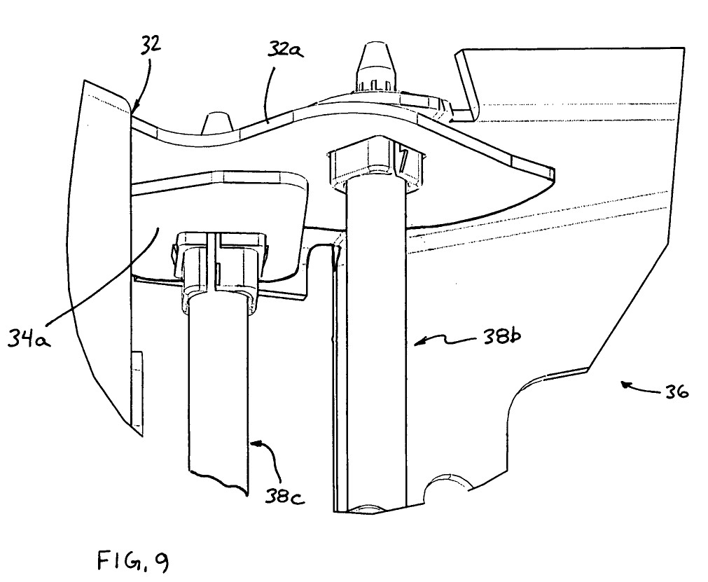

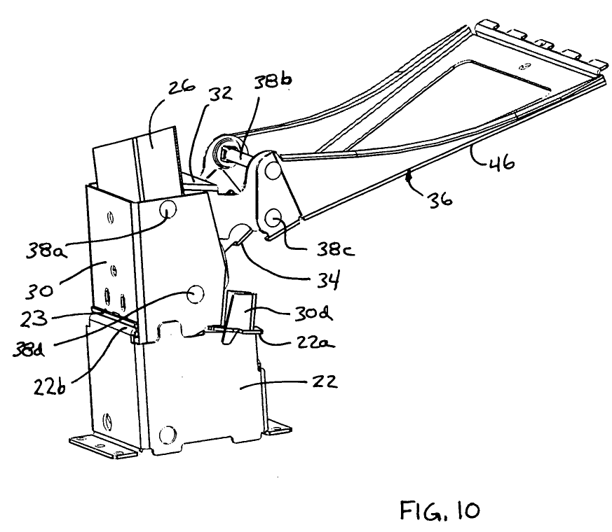

As best shown in FIGS. 7 and 8, base element 30 is a generally hollow bracket or element that attaches to an upper end of the base portion 22 (and/or may receive an upper end of the base portion therein or may otherwise engage the base portion) to attach the seat support and pivot mechanism 24 to the base portion 22. Base element 30 may be secured to the base portion 22 via one or more fasteners (not shown) or the like. For example, and as shown in the illustrated embodiment, base element 30 may include a curved tab 30d at each side of the lower end of base element 30, and base portion 22 may include an outwardly extending flange 22a at its upper end, whereby the tabs 30d may engage the flanges 22a when base element 30 is positioned at base portion 22, and fasteners (not shown), such as threaded fasteners, such as screws or bolts or the like, may be inserted into the curved tabs 30d and driven into the flanges 22a to secure the base element 30 to the base portion 22. In the illustrated embodiment, the tabs 30d are angled forwardly so that the fasteners may be readily driven into the flanges 22a by an operator installing the seat assemblies.

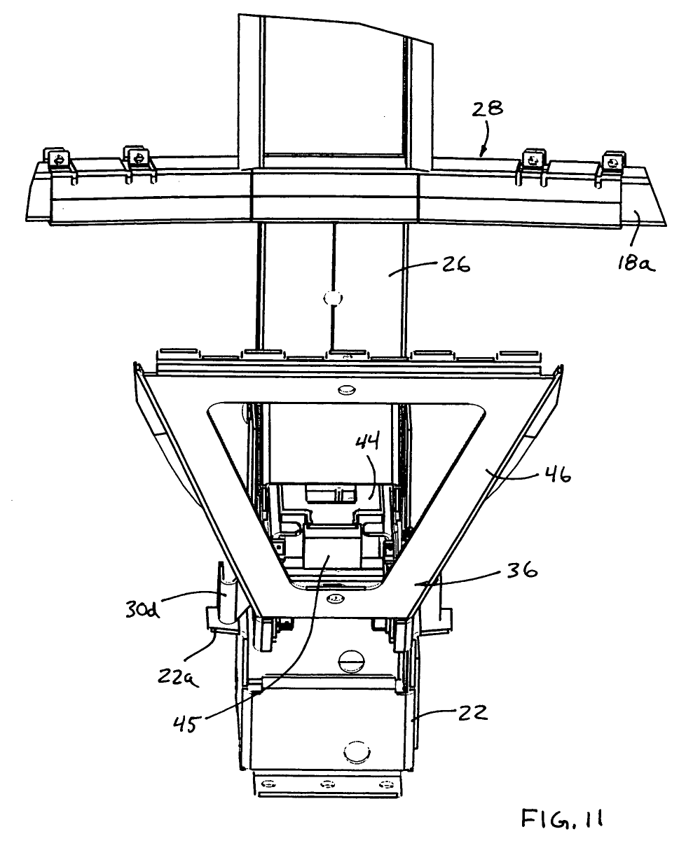

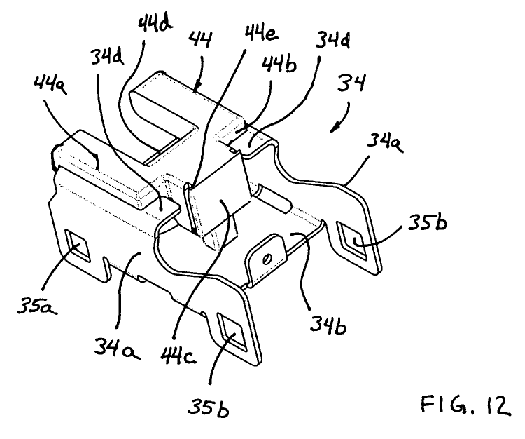

Optionally, base element 30 may include a mounting slot 30f (FIGS. 8, 14 and 28) for receiving a tab 22b (FIGS. 5, 7, 10 and 28) of base portion 22 to position and mount base element 30 at base portion 22. Slot 30f receives tab 22b therein to position the base element 30 relative to the base portion 22, whereby the curved tabs 30d then align with the flanges 22a of the base portion 22. Preferably, a retaining element 23 (FIGS. 5, 7 and 28), such as a plastic or polymeric retaining element or clip or the like, is provided at tab 22b of base portion 22, whereby the retaining element 23 and tab 22b are received in slot 30f of base element 30. The plastic retaining element 23 limits or substantially precludes metal-on-metal contact between the metal tab 22b and the metal of the base element 30, and thus may substantially reduce the possibility of squeaking of the seat assembly. The plastic retaining element 23 may be readily snapped onto tab 22b, and base element 30 may be positioned so that retaining element 23 is received through slot 30f, whereby the curved tabs 30d of base element 30 (and other components or elements, such as the pivot assembly and back rest support and arms and seat portions and back rests and/or the like) are aligned with the flanges 22a to ease assembly of the seat assembly.

The seat support and pivot assembly 24 thus may be fully assembled, and may even have the arms and seat and back rest cushions attached thereto (as discussed below), whereby the fully assembled or at least partially assembled seat assembly may be readily attached to the base portion 22 by an operator (who may position the base element relative to the base portion so as to receive the tab and retaining element in the slot of the base element, and may hold or steady the seat assembly with one hand while readily driving the threaded fastener through the flange 22a to secure the seat assembly to the base portion 22). Thus, the seat assembly may be assembled at the base portion or may be assembled before attaching the base element to the base portion, depending on the desired approach of the installation operators and/or the particular application of the seat assemblies and seating system. The base portions thus may be secured to the floor at the desired and predetermined or planned spacings and the seat assemblies with common support assemblies may be readily mounted to the base portions or assembled at the base portions to complete the installation of the seating assemblies and seating system, as discussed below.

Base element 30 includes an upper pair of openings or apertures 30a for pivotally attaching upper pivot element 32 to base element and a lower pair of openings or apertures 30b for pivotally attaching lower pivot element 34. Base element 30 receives a lower end of the back rest support member 26, which may be adjustably attached to the base element 30, such as discussed below.

Upper pivot element 32 includes a pair of opposite side plates 32a and an upper cross member or plate 32b connecting the side plates 32a. The side plates 32a include rear mounting apertures 33a for pivotally mounting upper pivot element 32 at the apertures 30aa of base element 30a, such as via a pivot pin or axle 38a or the like. The side plates 32a also include forward mounting apertures 33b for pivotally attaching the seat support element 36 to upper pivot element 32, such as via a pivot pin 38b or the like. In the illustrated embodiment, upper pivot element 32 includes a bracing notch 33c formed along a lower edge region of the side plates 32a and generally below the forward mounting apertures 33b. The bracing notch 33c engages a pivot pin 38c or fastener or the like at the lower pivot element 34 when the seat support is lowered to the lowered or in use position. Thus, the bracing notch and side plates 32a of upper pivot element 32, when engaged with the pivot pin 38c at or near the side plates 34a of the lower pivot element 34, limits side-to-side or lateral movement or displacement of the seat support element and seat portion relative to the base portion, and thus provides enhanced structural rigidity to the seat support mechanism when the seat support element is lowered to the lowered or in-use position, as discussed below.

Lower pivot element 34 includes a pair of opposite side plates 34a and a lower cross member or plate 34b connecting the side plates 34a. The side plates 34a include rear mounting apertures 35a for pivotally mounting the lower pivot element at the apertures 30b of base element 30, such as via a pivot pin 38d or the like. The side plates also include forward mounting apertures 35b for pivotally attaching the seat support element 36 to upper pivot element 34, such as via pivot pin 38c.

In the illustrated embodiment (and as best shown in FIG. 8), the pivot pins 38a-d comprise hollow tubes or cylinders 39a positioned through or between some of the apertures, with a pin or bolt or fastener 39b inserted through each tube to hold the tube in place while allowing pivotal movement of the respective elements. The tubes 39a and pins 39b may be received in plastic bushings 39c positioned at the apertures (such as in generally square-shaped or rectangular-shaped apertures) of the respective upper and lower pivot elements 32, 34. The bushings and tubes allow for pivotal movement of the respective components relative to one another, and may be readily assembled together, such as in the field and/or at the installed base portions. Also, the bushings and tubes may function to limit inward deflection of the side plates of the respective elements when fasteners (such as a nut 39d′ at an end of the bolt 39b′ in FIG. 7) are tightened, while still facilitating relative pivotal movement of the attached elements. Optionally, the pivot pins may comprise single pins that extend through the corresponding and aligned apertures of the support elements, or other means for pivotally attaching the elements may be implemented, without affecting the scope of the present invention.

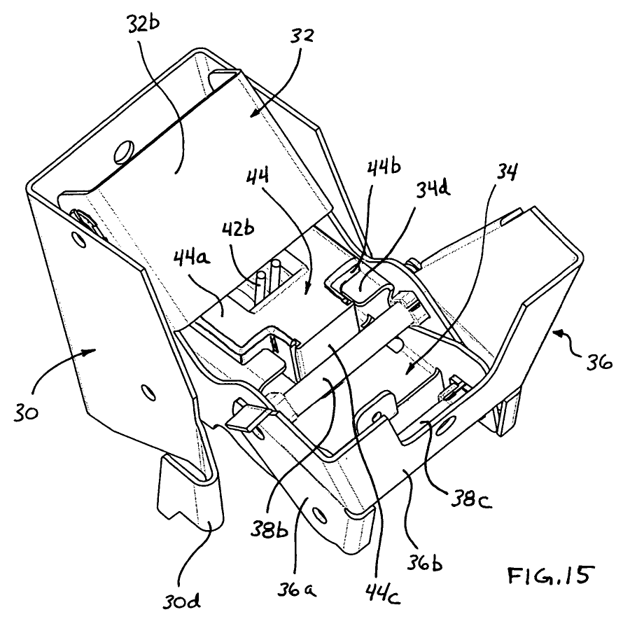

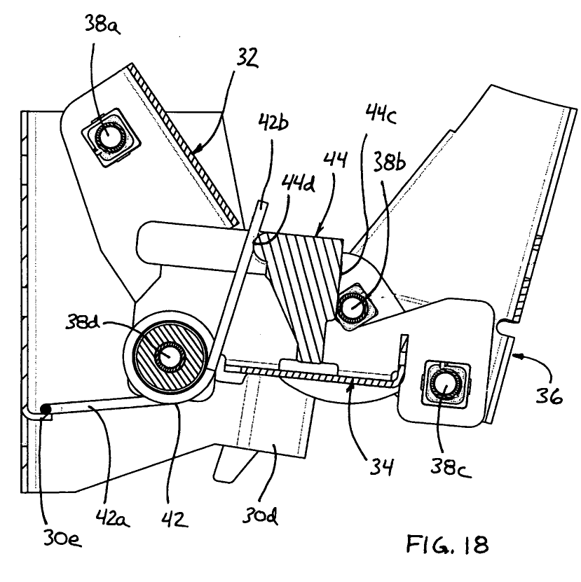

Lower pivot element 34 includes a biasing element or spring 42 at the pivot mount or junction between lower pivot element 34 and base element 30. The spring 42 may be retained at lower pivot element 34 (and between the sidewalls 34a of lower pivot element 34) via pivot pin 38d, such as via pivot pin 38d received through a spring mounting bearing or support 43 (FIGS. 7 and 8). In the illustrated embodiment, spring 42 comprises a torsion spring that includes one end or leg 42a that engages a tab or stop 30e (FIGS. 14, 16 and 18) of base element 30 and an opposite end or leg 42b that engages and acts against a surface 44d of a seat stop or overtravel cam 44 at lower pivot element 34 (discussed below), and functions to urge or bias lower pivot element downward so as to bias or urge or raise the seat support element 36 toward its raised position, as discussed below.

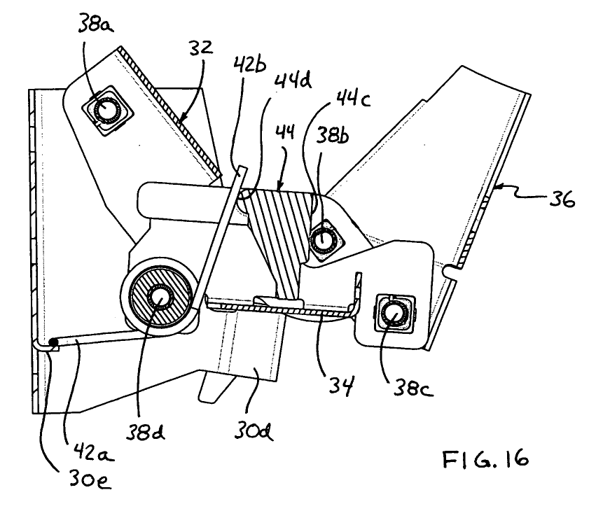

In the illustrated embodiment, lower pivot element 34 includes one or more mounting flanges 34c (FIG. 8) for attaching a seat stop or overtravel cam 44 thereto, and includes one or more stop tabs 34d for limiting movement of seat stop 44 along flanges 34c, as discussed below. In the illustrated embodiment, seat stop 44 comprises a generally Y-shaped element (and may comprise any suitable material, such as an elastomeric material or metallic material or the like) with a pair of slide portions 44a for slidably or movably receiving flanges 34c (FIG. 8) of lower pivot element. Seat stop 44 also includes a contact surface 44b at the end of each slide portion 44a for engaging the stop tabs 34d when the seat stop is urged toward the tabs 34d by spring 42 (as can be seen with reference to FIG. 15). Seat stop 44 also includes a stop surface or contact surface 44c for contacting and limiting movement of the pivot pin 38b when the seat support is biased or urged toward its upright or stored position, as discussed below. The seat stop 44 thus is slidable or movable along flanges 34c and engages the pivot pin 38b when the seat support is raised or pivoted to its raised or non-use position (as can be seen in FIGS. 15 and 16), in order to limit the upward pivotal range of movement of the seat support element 36. Optionally, a spacer or stop element or block 45 may be attached to seat stop 44 (at contact surface 44c) to provide a different stop location for engaging the pin 38b (and thus a different fold angle of the seat assembly), such that the addition of the stop element 45 will result in a different upright position of the seat support, as also discussed below.

Seat support element 36 includes a pair of opposite side plates 36a and a cross member or plate 36b connecting the side plates 36a. Side plates 36a include upper mounting apertures 37a for pivotally attaching the seat support element 36 at the forward apertures 33b of upper pivot element 32 via pivot pin 38b and lower mounting apertures 37b for pivotally attaching the seat support element 36 at the forward apertures 35b of lower pivot element 34 via pivot pin 38c. Seat support element 36 includes a seat mounting portion or member or frame or element 46, which may be integrally formed with or welded or otherwise attached to the seat support element and extends outwardly therefrom. For example, and optionally, a seat mounting member 146 (FIGS. 30-32) may be attached to seat support element 136, such as via clamping or otherwise securing the seat mounting member 146 between clamping plates or the like via one or more fasteners or bolts or the like, without affecting the scope of the present invention.

In the illustrated embodiment, seat mounting member 46 comprises a generally triangular-shaped flange or formed member. The seat mounting member 46 is configured to attach to a seat portion 14, and may be sandwiched between the upper seat portion or cushion 14 and a lower seat portion or casing 15 (such as shown in FIG. 5), whereby the upper and lower seat portions may be secured together and may be fixedly attached to the seat mounting member 46 and, thus, to the seat support element 36. As shown in FIG. 5, the upper seat portion 14 may include a mounting or base substrate or portion 14a and an upper cushion portion 14b, while the lower seat portion 15 may include a plastic or polymeric or metallic structure or encasement for covering or concealing the seat mounting member 46. Optionally, the seat portion or cushion may include only the upper seat portion 14, such as shown in FIGS. 1-4, without affecting the scope of the present invention.

The seat portion 14 and/or the lower cover or casing 15 may be secured relative to the seat mounting member 46 via any securing or fastening elements or means, such as via bolts or fasteners or snap connectors or the like, or may be secured or snapped together around the seat mounting member with the seat mounting member clamped or secured therebetween, without affecting the scope of the present invention. The lower casing and seat portion thus may be secured together in a clamshell type manner to secure the lower casing and seat portion to the seat mounting member. Optionally, and as shown in FIGS. 2A and 2B, the upper seat portion 14a may include tabs 14c for engaging corresponding tabs or recesses or slots in the lower cover or casing 15 to assist in attaching the lower cover or casing 15 to the seat assembly, such as to assist in providing a snap connection or fastenerless connection of the lower cover or casing to the seat assembly. Such a snap connection, or even a fastener connection, facilitates removal of the seat portion 14 and cover 15 to facilitate change over or updating of the external appearance of the seat assemblies in the field, by attaching new seat portions and covers and without having to remove or rework the base structures or support assemblies of the seats at the facility.

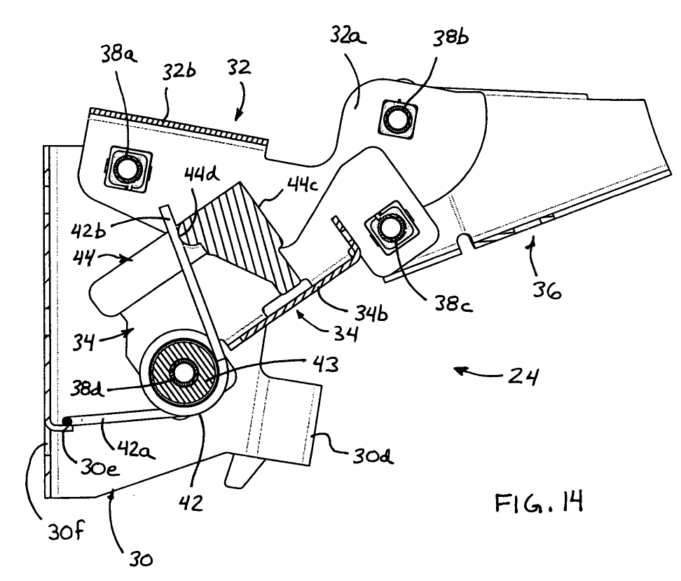

The upper and lower pivot elements 32, 34 and the seat support element 36 thus pivot relative to one another and relative to the base element 30 of the seat support and pivot mechanism 24 as the seat mounting member 46 and seat portion 14 are raised and lowered by a user. The dual linkage arrangement provides pivotal movement of the seat support element relative to the base element about four pivot axes (as defined by the pivot pins 38a-d), which allows for easier pivotal movement (such as by a person lowering the seat portion to the lowered position) and allows for the substantial locking support of the pivot linkages and the seat support element when the seat support element is in the lowered position (via the engagement of the bracing notch 33c of the upper pivot element 32 with the pivot pin 38c of the lower pivot element 34). As can be seen in FIGS. 2A, 4, 10, 13 and 14, when the seat portion is lowered to its in use position, the upper and lower pivot elements 32, 34 extend generally outwardly from the base element 30, with the seat support element 36 extending from the upper and lower pivot elements 32, 34 generally horizontally or at an upward angle relative to the support surface or floor. When the seat portion is lowered to its lowered or in-use position, the bracing notch 33c of upper pivot element 32 engages pivot pin 38c of lower support element 34, or receives pivot pin 38c therein, to limit further downward or pivotal movement of the seat support element and seat portion and to provide enhanced structural rigidity to the seat support and pivot mechanism 24 in the lowered position (by providing a locking type function at and between the outer ends of the upper and lower pivot elements).

When the seat assembly is not in use, the seat portion may be readily pivoted or raised upward to its raised or stored position (FIG. 2A), and may be biased toward the raised position via the biasing element or spring 42. As described above, biasing element or spring 42 may comprise a torsion spring and functions to act against surface 44d of seat stop 44 to urge or bias the lower pivot element 34 to pivot about pivot pin 38d relative to base element 30 (such as in the clockwise direction in FIGS. 14, 16 and 18). As the lower pivot element 34 is pivoted relative to base element 30 about pivot pin 38d (such as in the clockwise direction in FIG. 14), seat support element 36 pivots relative to lower pivot element 34 and upper pivot element 32 (such as in the counter clockwise direction in FIG. 14), which causes upper pivot element 32 to pivot downward (such as in the clockwise direction in FIG. 14) relative to base element 30 and about pivot pin 38a. Thus, the seat support element is lowered at its mounting end as it folds upward so as to provide a reduced envelope or occupied space or height of the seat support element and seat portion when in the raised or storage position. When the seat portion is pivoted to its raised position (such as via the spring urging the lower pivot element downward and thus pivoting the seat portion upward when a person is not moving or pushing the seat portion downward toward the lowered position), pivot pin 38b engages stop surface 44c of stop element or seat stop 44 (as shown in FIGS. 15 and 16) to limit further movement of the seat portion.

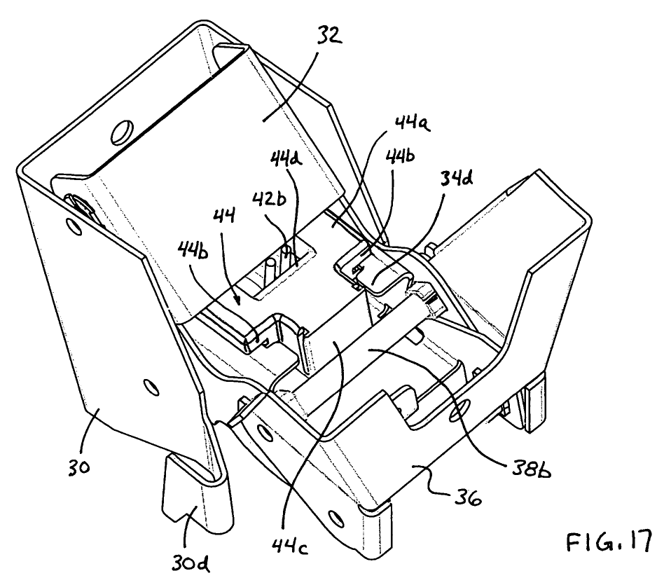

Further pushing or urging of the seat support element 36 toward the seat back (such as may occur when a person pushes or moves the seat cushion further toward the seat back to make additional room for a person to pass down the row of seat assemblies) pushes the seat stop 44 against the ends or legs 42b of spring 42 and moves seat stop 44 along the flanges 34c of lower pivot element 34 (so that the surfaces 44b of seat stop 44 are spaced from the stop tabs 34d as can be seen in FIG. 17). The seat stop 44 thus allows for further pivotal movement of the seat support element 36 toward the seat back, and biases or urges the seat support element back toward the nominal or storage position (via the legs 42b of spring 42 urging seat stop 44 forward along the flanges 34c of lower pivot element 34 until the surfaces 44b of seat stop 44 engage the stop tabs 34d) when the person no longer is pushing the seat portion toward the seat back.

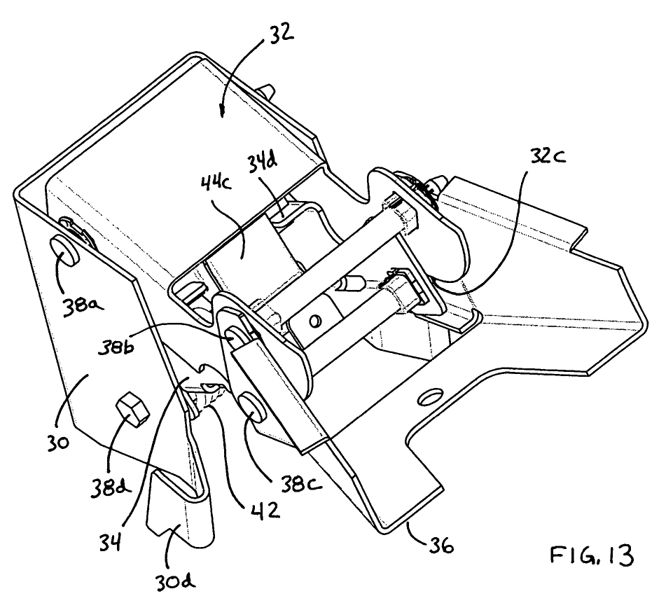

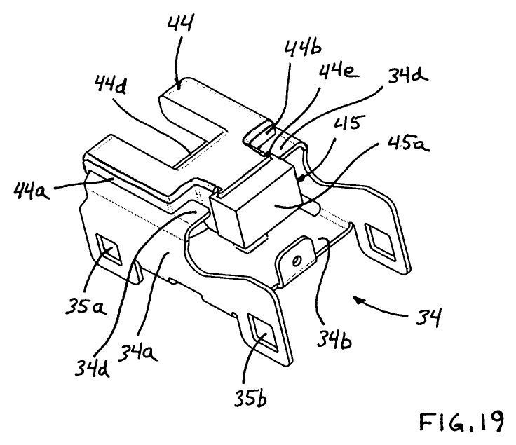

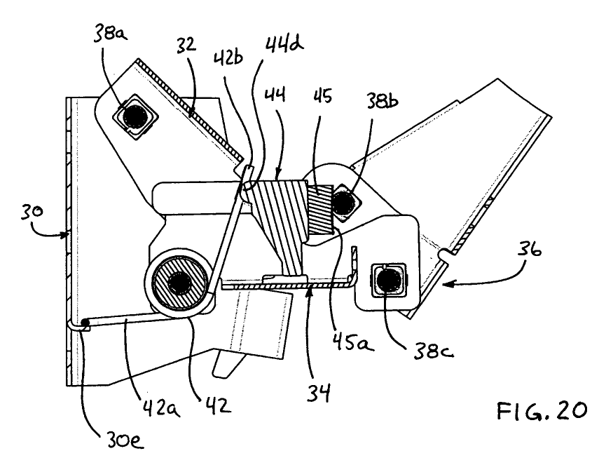

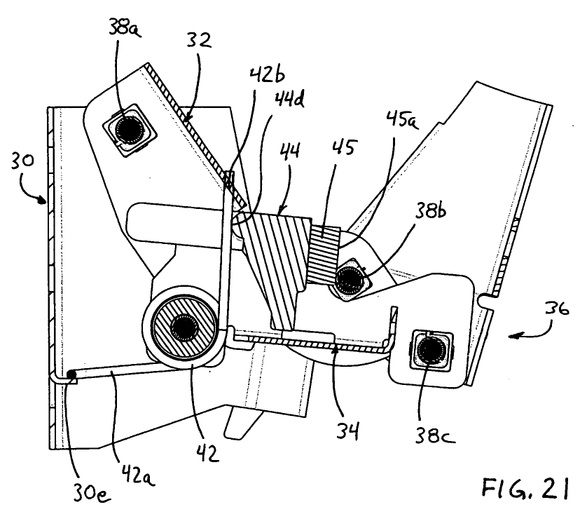

As can be seen with reference to FIGS. 12-18, the seat stop 44 provides a stop surface 44c that engages pivot pin 38b when the seat support element 36 is pivoted upward to a particular raised or stored position, such as a first selected degree of pivoting of the seat support element 36. By adding the stop element 45 to seat stop 44 (such as by slidably positioning the stop element along tabs or flanges 44e of seat stop 44, as shown in FIGS. 12 and 19), the stop element 45 provides a stop surface 45a that is raised or extended from stop surface 44c so as to limit upward pivotal movement of the seat support element 36 at a second location (that is lower than the first location provided by the stop surface 44c). The fold angle or degree of upward pivotal movement thus may be adjusted by adding or removing the stop element 45 (or by providing a different stop element that has a different thickness than stop element 45) so that the pin 38b engages the desired stop surface of the stop element 45 or seat stop 44. For example, the stop surfaces (or thickness of the stop element or presence/absence of the stop element) may be selected to limit the fold angle to a particular or desired angle, such as a half fold angle or a full fold angle, depending on the desired seat orientation when not in use and, thus, depending on the particular application of the seat assembly and seat system.

Seat support and pivot mechanism 24 also supports the back rest support member 26, which is received in or attached to the seat support and pivot mechanism 24 and which extends generally upwardly therefrom. Back rest support member 26 comprises an elongated, curved member that may curve to correspond to the desired contour or curvature of the back rest portion 16 that is attached thereto. The back rest portion 16 may be attached to the back rest support member 26 via any attachment means, such as fasteners or bolts or screws or snap connectors or the like, and/or may include a rear casing (such as a rear casing 17a (FIGS. 5 and 26), and optionally a center panel or structure 17b, as shown in FIG. 26) that attaches to the back rest and/or the support member and substantially conceals the back rest support member and cross member at the rear of the seat assembly or chair. The rear casing and back rest thus may be secured together in a clamshell type manner to secure the rear casing and back rest to the back rest support member. The rear casing may comprise a plastic or polymeric casing or back 17a or may comprise a wooden panel 17a′ (FIG. 26) or other rear panel or casing or the like, without affecting the scope of the present invention. The rear casing and back rest may be secured together via fasteners or may snap together or otherwise secure together without fasteners, without affecting the scope of the present invention. Desirably, the back rest and cover may be detachable so as to facilitate removal and replacement of the back rest and/or cover, whereby the seat assemblies may be repaired or updated or changed without having to replace or rework the base or core structures of the seat assemblies.

The lower end 26a of back rest support member 26 is received within the base element 30 of the seat support and pivot mechanism 24. In the illustrated embodiment, back rest support member 26 is pivotally attached to the base element 30 via pivot pins 38a and 38d through the apertures 30a, 30b of base element 30 and through the corresponding apertures 26b, 26c of back rest support member 26. As shown in FIG. 7, the lower aperture 26c of back rest support member 26 may comprise an arcuate slot 26c, such that loosening of the pivot pin 38d allows for movement of pin 38d along slot 26c to allow for pivotal movement of back rest support member 26 about pivot pin 38a. For example, the pivot pin 38d may comprise a fastener 39b′, such as a threaded bolt, whereby the bolt may extend through circular openings 30b in the base element 30 and through slotted opening 26c in the back rest support member 26. A female fastener or nut 39d′ at the threaded end of the fastener or bolt 39b′ may then be tightened to substantially clamp the back rest support member 26 relative to the base element 30 when the back rest support member is pivoted to the desired orientation about the pivot pin 38a.

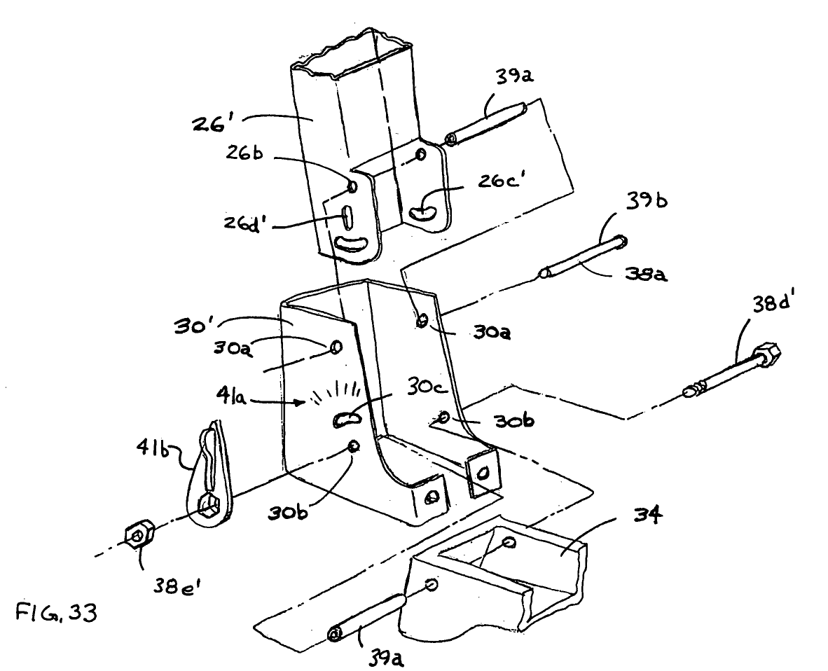

Optionally, and as shown in FIG. 33, the base element (such as base element 30′ in FIG. 33) and/or the back rest support member 26′ may include markings or indicia 41a and/or a pointer or indicator 41b or the like to indicate the angle of the back rest support member relative to the base element, in order to enhance the adjustment of the back rest support member to the desired angle and/or orientation. The indicator 41b may be substantially fixed relative to the back rest support via a protrusion (not shown in FIG. 33) protruding from the indicator and through a slotted opening 30c′ in base element 30′ and into an opening 26d′ in back rest support member 26′. The indicator 41b thus may pivot with the back rest support member relative to the base element to indicate the angle of the back rest support member at the markings or indicia on the base element.

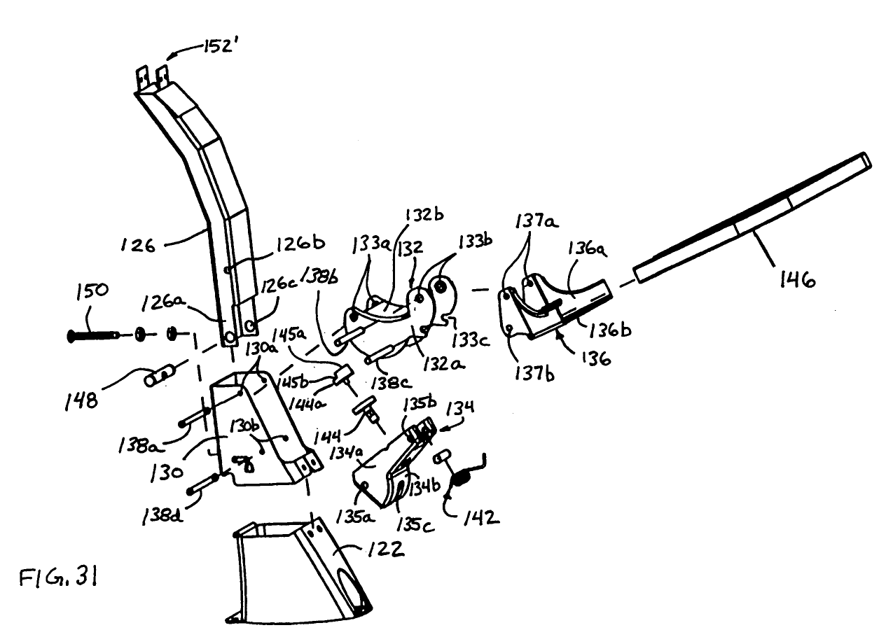

The back rest support member supports cross member or arm mounting member 28 for adjustably attaching the adjustable arm support 18 to the support assembly 12. The arm mounting member 28 may be received in a notch 52 in the back rest support member 26 (as can be seen with reference to FIGS. 5 and 7), or may be attached to a bracket 152′ at the upper end of the back rest support member (as shown in FIG. 31), or may be otherwise attached to or welded to or formed with the back rest support member 126, without affecting the scope of the present invention. The arm mounting member 28 extends laterally in either or both directions from the back rest support member 26 for receiving or attaching to an arm support 18 at either or both ends.

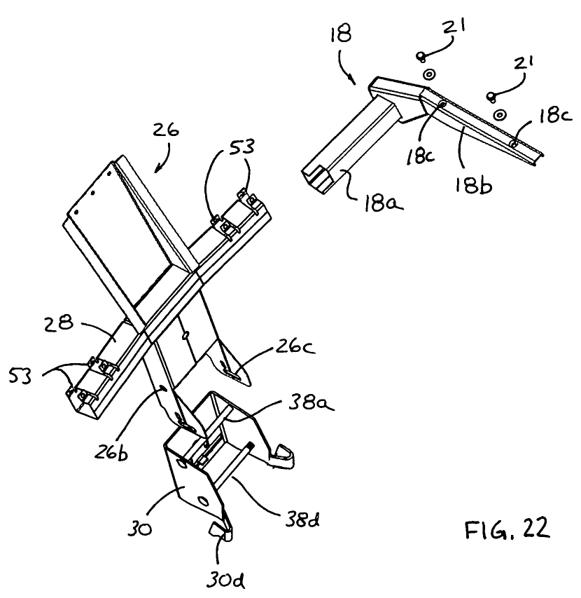

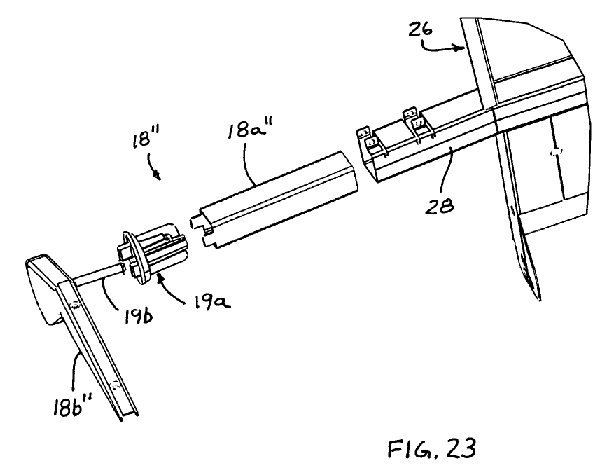

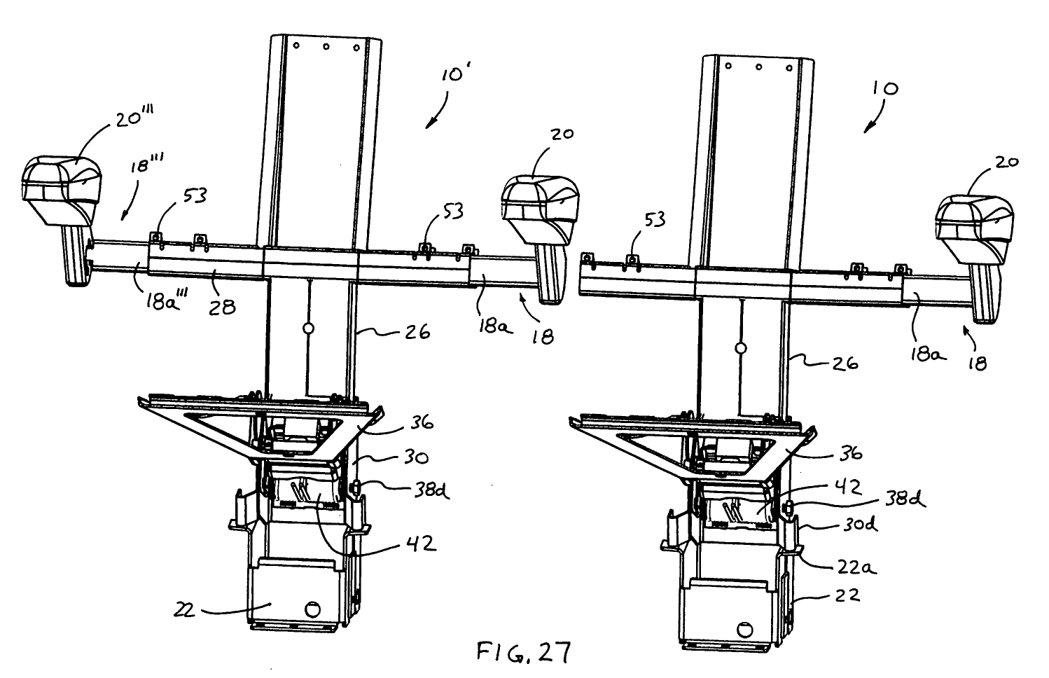

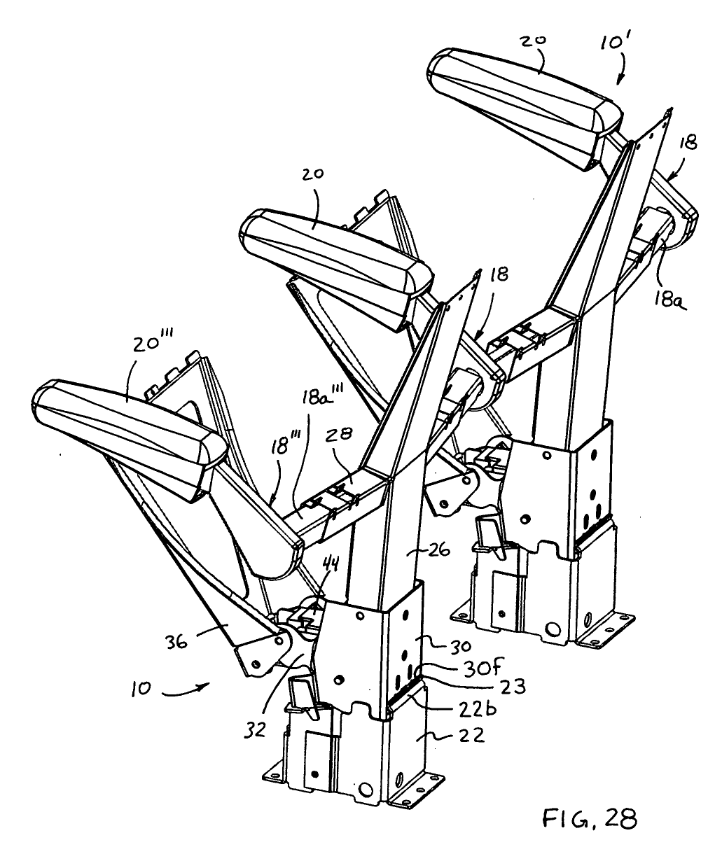

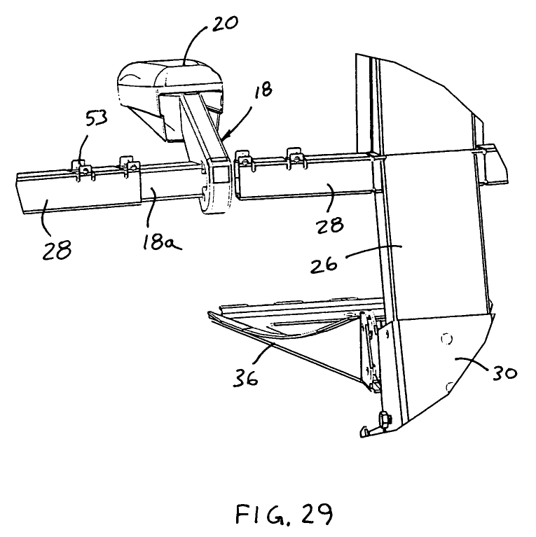

The arm support 18 comprises a curved or bent or formed member with a mounting end or portion 18a and an arm support end or portion 18b. In the illustrated embodiment, the arm mounting member 28 comprises a tubular member that adjustably receives mounting end 18a of arm support 18 therein. Optionally, the mounting end of the arm support may receive an end of the arm mounting member, without affecting the scope of the present invention. Lateral movement or adjustment of the mounting end 18a of arm support 18 relative to the arm mounting member 28 adjusts the lateral position of the arm support portion 18b and arm rest 20 relative to the support assembly 12 and base portion 22. The arm support 18 may be selectively laterally adjusted relative to arm mounting member 28 and then secured to the arm mounting member 28 when in the desired or appropriate location relative to the arm mounting member 28. For example, and as shown in FIGS. 22 and 23, arm mounting member 28 may include clamping tabs 53 through which a fastener (not shown) may extend and whereby tightening of the fastener (such as a male fastener or bolt and a female fastener or nut or such as a screw or the like) flexes the clamping tabs toward one another to substantially clamp the mounting end 18a of arm support 18 within arm mounting member 28 to secure the arm support 18 at the desired position relative to the mounting member 28. Optionally, the mounting end of the arm support and/or the arm mounting member may include a plurality of holes or apertures 153 (FIG. 30) for receiving a fastener or the like to secure the arm support relative to the arm mounting member at the desired lateral position. The arm support and arm rest may be attached to one side or end of the cross member for each seat assembly in the row, and the seat assembly or chair at one end of the row may include an arm support and arm rest at both sides or ends of the cross member, such as the seat assembly 10′ shown in FIGS. 6, 27 and 28. For example, a row end seat assembly 10′ may include an arm support 18 and arm rest 20 at one side of the mounting member 28, and may include an arm support 18′″ and arm rest 20′″ at the other side of mounting member 28. Arm support 18′″ may be substantially the same as arm support 18, but a mirror image thereof, with an arm mounting end 18a′″ extending in the opposite direction to facilitate mounting the arm support 18′″ at the opposite end of the mounting member 28 (and thus at the opposite side of the seat assembly), such as in a similar manner as described above.

Optionally, and as shown in FIG. 23, an adjustable arm support 18″ may include a mounting portion 18a″ that attaches to the arm mounting member 28 at one end and that receives a pivotal arm attachment or connection 19a at its opposite end. The pivotal arm attachment 19a pivotally receives a pivot shaft 19b of an arm support portion 18b″ so that the arm support portion 18b″ may pivot about a generally horizontal pivot axis relative to the arm mounting member 28, such as for pivotally attaching a flip-up or adjustable arm support and arm rest. Other adjustable arm support configurations may be implemented (such as, for example, arm rests of the types shown at B in FIG. 26), without affecting the scope of the present invention.

Arm rest 20 may be adjustably mounted to or attached to the arm support portion 18b of arm support 18, such that the lateral position and angle of the arm rest 20 may be adjusted relative to the arm support 18. For example, arm rest 20 may include slots for receiving fasteners (such as fasteners 21 as shown in FIG. 22), which are inserted through apertures 18c in arm support portion 18b, such that the arm rest 20 may be adjustably positioned at the desired location and orientation relative to the arm support portion 18b while the fasteners are loose, and then substantially secured to the arm support portion 18b via tightening of the fasteners.

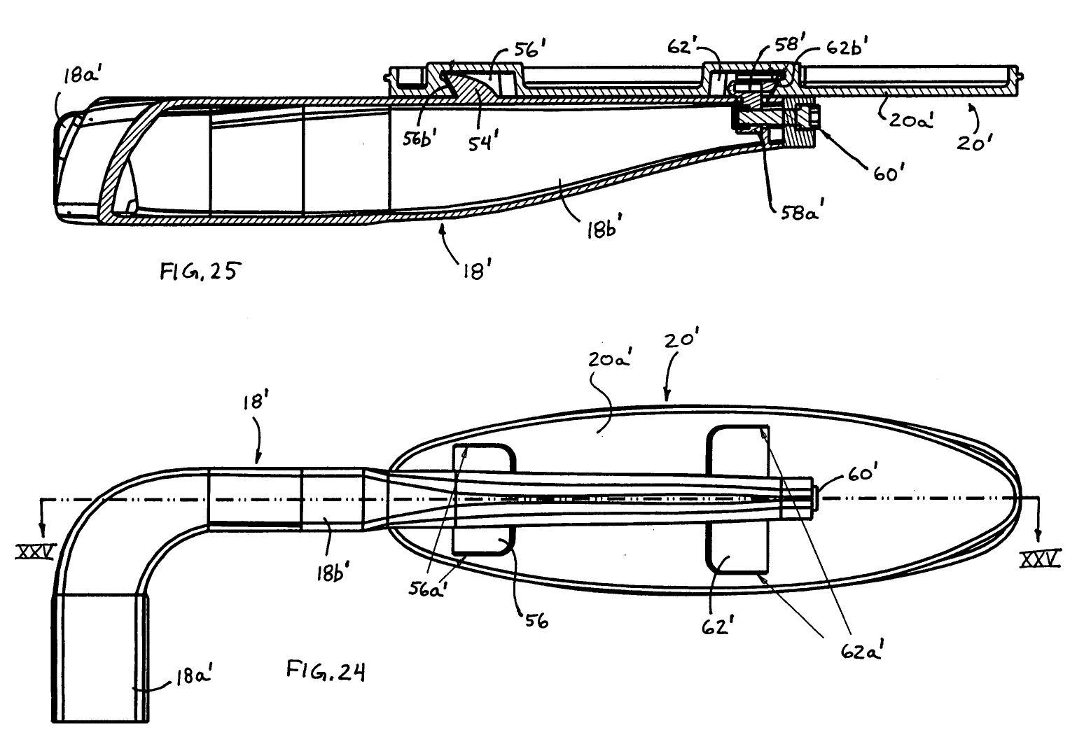

Optionally, the arm rest may be otherwise adjustably mounted to the arm support portion to allow for adjustment of the angle and lateral position of the arm rest relative to the arm support portion and to the seat assembly, without affecting the scope of the present invention.. For example, and with reference to FIGS. 24 and 25, an arm rest 20′ may be adjustably mounted to an arm support portion 18b′ of an arm support 18′ (which may be adjustably mounted to the arm mounting member or back rest support via a mounting end 18a′, such as in a similar manner as described above) via an adjustable tab or retaining member 58′ (arm rest 20′ is shown in FIGS. 24 and 25 without the upper cushion so that the mounting plate 20a′ of the arm rest may be clearly shown in the figures). Arm support 18′ includes raised tab or retaining member 54′ that protrudes upwardly from the arm support portion 18b′ and that is received within a rear channel or slot 56′ of mounting plate 20a′ of arm rest 20′. Arm support 18′ also includes an adjustable tab or retaining member 58′ that is adjustably positioned at an outer or forward end of the arm support portion and that is adjustable via adjustment of a threaded fastener or adjusting device 60′. The adjustable tab 58′ is received within a front channel or slot 62′ of mounting plate 20a′ of arm rest 20′ and functions to clamp or secure the arm rest 20′ to the arm support when the adjusting device 60′ is adjusted or tightened. The adjusting device 60′ may comprise a threaded bolt or the like that is threadedly received in a threaded base portion 58a′ of the adjustable tab, whereby rotation of the adjusting device 60′ imparts a generally translational movement of the adjustable tab 58′ along the arm support.

For example, the arm rest 20′ may be placed onto the arm support 18′, with the retaining member 54′ inserting into the rear channel 56′ and the adjustable tab 58′ loosely received in the front channel 62′ of arm rest 20′. The side-to-side or lateral position and the angle of the arm rest relative to the longitudinal axis of the arm support portion may then be adjusted to provide the desired lateral position and angle of the arm rest. As can be seen in FIG. 24, the lateral sides 56a′, 62a′ of the channels 56′, 62′, respectively, limit the lateral movement in either direction of the arm rest relative to the arm support. When the arm rest is positioned at the desired position and orientation, the adjusting device 60′ may be adjusted (such as by tightening the fastener), which may impart a translational movement of the adjustable tab 58′ (such as to the right in FIG. 25) to move or pull the arm rest and thus, to clamp the arm rest in the desired position and orientation via the tabs 54′, 58′ engaging opposite walls 56b′, 62b′ of the channels 56′, 62′. As can be seen in FIG. 25, the opposite walls 56b′, 62b′ of the channels are angled so that the corresponding angled tabs 54′, 58′ exert a longitudinal and downward force against the angled walls to substantially retain and secure the arm rest in the desired position when the adjusting device 60′ is tightened.

The lateral position of the arm support relative to the back rest support member 26 and the lateral position and angle of the arm rest relative to the arm support thus may be readily adjusted in the field and during the installation process to provide the desired effective width and angle of the seat assembly. When multiple seat assemblies are installed in a row, there are often different sizes or widths of seat assemblies implemented in the row to provide the desired viewing and desired overall length of the row with the desired or appropriate number of seat assemblies in that row. The base portions and support assemblies of the present invention may be spaced in a desired manner along the row and the arm support may be adjusted to provide the desired lateral position of the arm rest, while the seat supports and back rest supports may support the seats and back rests of the desired or appropriate widths. The seat assemblies of the present invention thus may provide the desired or appropriate width seat assemblies along the row, while having common seat support assemblies and base portions for all of the seat assemblies in the row or rows. The adjustable arm support facilitates field adjustability of the arm rest position to create multiple sizes (or effective widths) of seat assemblies from the same common components, thus decreasing the number of products required in the particular installation.

Optionally, other common support assemblies or pivot assemblies may be utilized in a modular seating system while remaining within the spirit and scope of the present invention. For example, and with reference to FIGS. 30-32, a modular seat assembly or chair 110 includes a support assembly 112 that supports a seat portion 114 and a back rest portion 116 and an adjustable arm support 118, such as in a similar manner as described above. Support assembly 112 includes a base or base portion 122 and a seat support and pivot mechanism or assembly 124 and a back rest support member 126. The seat support and pivot mechanism 124 comprises a four component or four member pivot assembly and supports and pivots the seat portion 114, while the back rest support member 126 supports the back rest portion 116 attach to a cross member or bar or arm mounting member 128 for attaching to the adjustable arm support 118. The base portion 122, seat support and pivot mechanism 124 and back rest support member 126 may be substantially similar to the base portion 22, seat support and pivot mechanism 24 and back rest support member 26 described above, such that a detailed discussion of the seat assemblies need not be repeated herein. The common or similar components are shown in FIGS. 30-32 with similar reference numbers as set forth above, but with 100 added to each reference number.

Similar to seat assembly 10 described above, seat support and pivot mechanism 124 of seat assembly 110 includes a base element 130 that attaches to the base portion 122 and that receives or attaches to the back rest support member 126. Base element 130 pivotally supports an upper pivot member 132 and a lower pivot member 134, which are each pivotally attached to base element 130 at one end and to a seat support element 136 at the other end. The upper and lower pivot members 132, 134 and seat support element 136 cooperate to define a mechanical linkage that pivots relative to the base element 130 to raise and lower the seat portion 114, such as described above.

Lower pivot element 134 may include a recess for receiving a biasing element or spring 142 therein. The spring 142 may be retained at or within the recess and/or lower pivot element 134 via pivot pin 138c, and may function to urge or bias the seat support element 136 toward its raised position. In the illustrated embodiment, lower pivot element 134 also includes a mounting stanchion for attaching a seat stop mount 144 thereto. The seat stop mount 144 pivotally or adjustably receives or mounts an elastomeric or rubber or polymeric stop element 144a for engaging the pivot pin 138b when the seat support is raised to its raised or non-use position, in order to limit the upward pivotal range of movement of the seat. The stop element 144a may provide different stop surfaces 145a, 145b for engaging the pin 138b, such that rotation of the stop element 144a will result in a different upright position of the seat support, as discussed below.

When the seat assembly is not in use, the seat portion may be pivoted or raised upward to its raised position, and may be biased toward the raised position via the biasing element 142. Biasing element 142 comprises a torsion spring and functions to urge or bias the seat support element 136 to pivot about pivot pin 138c relative to lower pivot element 134. As the seat support element 136 is pivoted relative to lower pivot element 134, upper pivot element 132 pivots downward relative to base element 130, while lower pivot element 134 also pivots downward relative to base element 130. When the seat portion is fully raised, pivot pin 138b engages stop element 144a to limit further movement of the seat portion. The stop element 144a may provide a raised stop surface 145a for limiting upward pivotal movement of the seat portion at a first location and a lowered stop surface 145b for limiting upward pivotal movement of the seat portion at a second location (that is higher or further than the first location). The fold angle or degree of upward pivotal movement may be adjusted by rotating the stop element 144a about 180 degrees so that the pin 138b engages the desired stop surface of the stop element. For example, the stop surfaces may be selected to limit the fold angle to a half fold angle or a full fold angle, depending on the desired seat orientation when not in use and, thus, depending on the particular application of the seat assembly.

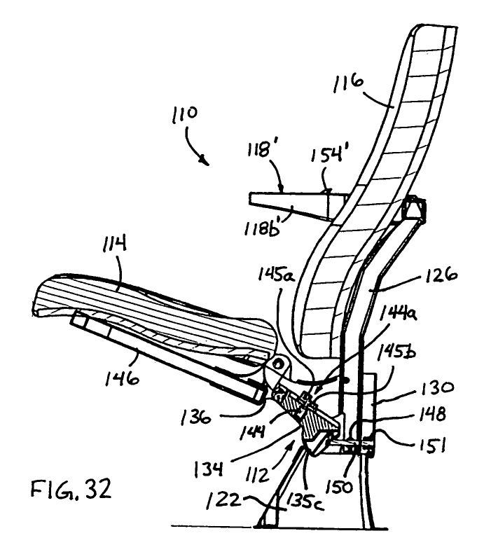

Optionally, the back rest support member of the seat assembly may be adjustably mounted to the base element of the pivot assembly. For example, the back rest support member 126 may be adjustably mounted in a manner such as described above with respect to back rest support member 26, or may be otherwise adjustably mounted to allow for selective pivoting or angling of the back rest support member relative to the base element to provide the desired degree of tilt of the back rest support member. For example, and with reference to FIGS. 31 and 32, a lower aperture or passageway 126c of back rest support member 126 may receive a threaded adjustment member 148, which may threadedly receive an adjustment device 150, such as a threaded bolt or the like. The adjustment device 150 may be attached to or may abut against the base element 130, such as via a non-threaded end of the adjustment device being rotatably received in an opening or aperture or recess 151 at the rear wall of the base element 130.

In the illustrated embodiment, the lower plate 134b of lower pivot element 134 includes an aperture or opening or slot 135c, which may provide access to the adjustment device 150 for adjusting the back rest support 126. The adjustment device 150 may be accessible from outside the base element 130 (such as through the opening or slot 135c in the lower pivot element 134 and from the front of the base element 130), whereby rotation of the adjustment device 150 relative to the adjustment member 148 causes translational movement of the adjustment member 148, which in turn imparts a pivotal movement of the back rest support member 126 about the pivot pin 138a to adjust the angle of the back rest support member. The tilt angle of the back rest support member 126 thus may be adjusted to the desired angle or setting, depending on the particular application of the modular seat assembly of the present invention. For example, the adjusting device may be adjusted to adjust the tilt angle or set back pitch of the back rest between about 12 degrees and about 24 degrees (or more or less), as desired. Although shown and described as having a threaded adjustment element that is rotated to adjust the tilt angle of the back rest support element relative to the base element, other means for adjustably mounting the back rest support member to the base element may be implemented, without affecting the scope of the present invention.

Accordingly, when a seating arrangement for a facility (such as an auditorium or theater or other facility suited for fixed seating) is selected or designed by a customer, the design of the particular seating layout and installation of the seat assemblies are substantially enhanced by the seating assembly and installation method of the present invention. Instead of having to design and select the different width seat assemblies and corresponding mounting brackets and other associated and size/design specific components, the designer need only determine the number of common support assemblies that are needed for each row and then determine the spacing and arm positions and seat widths and back widths for the seat assemblies of each row. All of the support assembly components and arm components are common components or elements (except that the end seat assembly at one end of each row may include a second arm assembly), such that order errors and shortages are limited or substantially precluded by the common or universal seat assemblies of the present invention. The different width seat portions and back rest portions may be readily installed to the appropriate seat supports and the arm may be readily adjusted to the desired position and orientation, in order to customize the seat assemblies for their particular application and location along the rows of chairs or seat assemblies.

Once the seating layout is designed (and thus a layout is generated that shows the number of seat assemblies in each row and which seat assemblies are of which size, such as which seat assemblies should be a 19 inch wide seat, a 21 inch wide seat or a 23 inch wide seat), an installer at the seating facility may follow the layout and attach the base portions at the appropriate locations along each row. For example, the installer may fasten or otherwise secure the base portions to the floor of the facility and at the designated or targeted locations along the rows. The common support assemblies are attached to the respective base portions, and the arm supports and arm rests may be adjusted to the desired position and orientation. In an exemplary embodiment of the seating assemblies of the present invention, the arm supports and arm rests may be adjusted to provide a range of effective widths of seats between about 19 inches and about 23 inches. If desired, different width seat cushions and back rest cushions may be attached to selected ones of the common support assemblies to provide different seating widths. The width or size of each seat assembly thus may be determined by the particular location at which the base portion is mounted along the floor, and the arm rest may then be adjusted accordingly during the installation process.

The installer may readily attach the seat cushion or portion and cover and the back rest and cover to the common support assemblies, such that the seat assemblies are substantially preassembled and ready for attachment to the appropriate base portions already secured to the floor (or other support) of the facility. Optionally, the common support assemblies may first be assembled and mounted to the installed base portions before the seat portions and back rests are attached to the support assemblies. Then, the installers may mount and adjust the arms and arm rests to the appropriate lateral position and angular orientation for the targeted or specified seat width of the respective support assembly, and may attach the appropriate width seat portions and back rests to the support assemblies to complete the assembly and installation of the seat assemblies.

The assembly and installation of the seat assemblies is thus substantially enhanced over prior art systems, since the only design specific or plan specific or layout specific components are the different width seat portions and back rests, if desired. All of the other components of the seat assemblies are common with all of the seat assemblies. Thus, the installers may install the common support assemblies to the common base portions without regard to any specific parts or part numbers, and then may install the layout specific seat portions and back rest portions to the appropriate support assemblies and may also adjust the arms and/or arm rests accordingly.

Optionally, if desired, the tilt angle of the back rest support and back rest may be adjusted to provide a desired degree of recline of the back rest, and/or the fold angle of the seat support and seat cushion may be adjusted to provide a desired degree or fold angle of the seat cushion when in the raised or non-use or storage position. Such adjustments may be made at the manufacturer or at the seating facility to customize the seating assemblies for the particular application and desired seating arrangement. Thus, when the support assemblies are shipped to the facility, the support assemblies may be set or adjusted for the particular design or plan as selected by the customer, yet will comprise the same or common parts and components as other support assemblies supplied by the seat manufacturer for other designs or layouts or facilities.

The common or universal support assembly and seat assembly of the present invention thus may be implemented in various applications or facilities, whereby the desired seat cushion, back rest and arm rest may be selected and installed, and the desired tilt angle, fold angle and effective width of the seat assemblies (as established by the selected seat portion and back rest and by the position of the arm rest) may be established during the installation process. For example, a desired pattern and/or color and/or shape/design of the seat cushions and back rests and the like may be selected for the seat assemblies of a particular facility or installation site, and the common support assemblies of the seat manufacturer may be supplied to the facility with the particular seat cushions and back rests, whereby the seat assemblies may be readily assembled with the desired or selected seat cushions and back rests and the like, and readily installed at the particular facility, with minimal planning of what components are necessary at the build site (since a vast majority of the components are common for each seat assembly so that only the number of seat assemblies need be known to plan the components to be shipped). Some or all of these adjustments may be made at the seat manufacturer or may be made by the installers at the seating facility during installation of the seat assemblies. Regardless of the desired external appearance of the seats as selected/designed by the customer, and regardless of the widths of the individual seats as set forth by the planned layout, the support assemblies and arms are common components for any application or facility and for each of the seats installed at any given facility.

The present invention thus provides simplified field layout development and simplified installation of the finished products, with fewer field errors and supply errors (such as overages and/or shortages of various components) and additional field adjustment capabilities. Because the seat assemblies or chairs of the present invention provide common support assemblies, the present invention also facilitates future changeover and/or enhancements of the seat cushions, back rests, arm rests and/or associated encasements, since these external components or items may be removed from the seat support and replaced as desired, without having to remove and replace the entire seat assemblies.

Therefore, the present invention provides a seating assembly or seating system or installation method that provides a systems approach to fixed seating that allows the creation of a wide range of products from a basic or common or core set of components. The seating system provides reduced complexity in the specification of the products or seat assemblies, and also provides reduced complexity in the manufacturing of the seat assemblies, since the common components may be readily manufactured and assembled in substantially the same manner for substantially all of the seat assemblies. The seating system of the present invention also provides reduced complexity in the design and installation of the seating system, since the field layout may be readily created and the common seat assemblies may be readily installed with reduced field errors and reduced ordering or supply concerns.

Changes and modifications to the specifically described embodiments may be carried out without departing from the principles of the present invention, which is intended to be limited only by the scope of the appended claims as interpreted according to the principles of patent law.

The embodiments of the invention in which an exclusive property or privilege is: claimed are defined as follows:

1. A method of fixedly installing a plurality of seat assemblies along multiple rows at a seating facility, said method comprising:
providing a plurality of common support assemblies, each of said support assemblies having a base portion, a seat support portion and a back rest support portion;
providing a plurality of first and second seat portions and a plurality of first and second back rests, said first seat portions having a different width than said second seat portions and said first back rests having a different width than said second back rests;
mounting said base portions at a support structure of the seating facility, said base portions being arranged in multiple rows at the support structure and being spaced from one another along said rows;
mounting said seat support portions and said back rest support portions to said base portions, said seat support portions being pivotable relative to said base portions to pivot said seat support portions between a lowered in-use position and an upper storage position;
selecting one of said first and second seat portions and one of said first and second back rests for each of said support assemblies;
attaching said selected seat portions and back rests to said seat support portions and said back rest support portions, respectively, of said support assemblies;
mounting an arm to each of said support assemblies; and
adjusting a lateral position of at least some of said arms relative to said support assemblies to adjust an effective width of at least some of said seat assemblies.

2. The method of claim 1, wherein mounting said seat support portions and said back rest support portions to said base portions comprises mounting said seat support portions and said back rest support portions to said base portions after said base portions are mounted at said support structure.

3. The method of claim 2, wherein attaching said selected seat portions and back rests is performed before said seat support portions and said back rest support portions are mounted to said base portions.

4. The method of claim 1, wherein mounting said seat support portions and said back rest support portions to said base portions comprises mounting said seat support portions and said back rest support portions to said base portions before said base portions are mounted at said support structure.

5. The method of claim 1, wherein the steps of attaching a seat portion to each of said seat support portions and a back rest to each of said back rest support portions and mounting an arm to each of said support assemblies are performed before mounting said seat support portions and said back rest support portions to said base portions.

6. The method of claim 1, wherein mounting said seat support portions and said back rest support portions to said base portions comprises mounting said seat support portions and said back rest support portions to respective base elements and mounting said base elements to said base portions.

7. The method of claim 6, wherein each of said seat support portions is pivotally mounted to said base element via a pair of pivot linkages.

8. The method of claim 7, wherein the step of mounting said seat support portions and said back rest support portions to respective base elements is performed before mounting said base elements to said base portions.

9. The method of claim 1 including adjusting a tilt angle of said back rest support portion relative to said base portion for each of said seat assemblies.

10. The method of claim 1 including adjusting a fold angle of said seat support relative to said base portion for each of said seat assemblies, said fold angle setting the range of pivoting of said seat support portion relative to said base portion between said lowered position and said raised position.

11. The method of claim 1 including selectively adjusting said arm between first and second lateral positions to provide first and second effective widths for said seat assemblies, said first lateral position of said arm being selected for seat assemblies with said first seat portion and said first back rest selected therefor.

12. The method of claim 1 including adjusting said arm to adjust an angle of said arm relative to said seat support.

13. A seating system for arranging a plurality of seat assemblies in multiple rows at a seating facility, said seating system comprising:
a plurality of seat assemblies, said plurality of seat assemblies being configured to be fixedly installed in rows of seat assemblies at a seating facility, each of said seat assemblies comprising a support assembly having a base portion, a seat support portion and a back rest support portion, each of said seat assemblies having an arm adjustably mounted to said support assembly and laterally adjustable relative thereto;
said support assemblies of said seat assemblies comprising common base portions, common seat support portions, common back rest support portions and common arms;
said base portions of said common support assemblies being configured to be fixedly secured to a support structure of the seating facility;
said seat support portions supporting respective seat portions and said back rest support portions supporting respective back rests, said seat support portions being pivotally mounted to said base portions and being pivotable relative to said base portions to pivot the respective seat support portions and said seat portions between a lowered in-use position and a raised storage position, said back rest support portions being attached to said base portions; and
each of said arms being selectively laterally adjustable relative to said support assembly to adjust an effective width of said seat assembly to a desired effective width for each of said seat assemblies along the rows of seat assemblies.

14. The seating system of claim 13, wherein each of said arms is angularly adjustable relative to said support assembly to adjust an angle of said arm relative to said support assembly.

15. The seating system of claim 13, wherein said seat support portion is adjustable relative to said base portion to selectively set a seat fold angle of the respective seat assembly.

16. The seating system of claim 13, wherein said back rest support portion is adjustable relative to said base portion to selectively set a back rest angle of said respective seat assembly.

17. The seating system of claim 16, wherein said seat support portion is pivotally mounted to said base portion via a pair of pivot elements, each of said pair of pivoting elements being pivotally attached to said base portion and said seat support portion being pivotally attached to said pair of pivoting elements.

18. The seating system of claim 17, wherein one of said pivoting elements engages a portion of the other of said pivoting elements when said seat support portion is pivoted to said lowered position to substantially secure said seat support portion at said lowered position.

19. The seating system of claim 13, wherein said seat portion for each of said seat assemblies is selected from at least two seat portion sizes and said back rest for each of said seat assemblies is selected from at least two back rest sizes to provide at least two different width seat assemblies with common support assemblies.

20. The seating system of claim 19, wherein said arm is selectively laterally adjusted depending on which size seat portion and which size back rest is selected for the respective seat assembly.

21. A seat assembly for a seating facility, said seat assembly being adaptable for different seat sizes and orientations, said seat assembly comprising:
a base portion that is configured to be fixedly secured to a fixed support structure at said seating facility;
a back rest support mounted to said base portion;
a seat support pivotally mounted to said base portion;
an arm support for supporting an arm of said seat assembly, said arm support being adjustably mounted to said back rest support, said arm support being selectively laterally adjustable to adjust an effective width of said seat assembly;
a back rest mounted on said back rest support; and
a seat portion mounted on said seat support, said seat support being pivotable to pivot said seat portion between a lowered in-use position and a raised storage position.

22. The seat assembly of claim 21, wherein said arm is adjustably mounted to said arm support and is adjustable to adjust an alignment angle of said arm relative to said arm support.

23. The seat assembly of claim 21, wherein said seat support is pivotally mounted to said base portion via a pair of pivoting elements, each of said pair of pivoting elements being pivotally attached to said base portion and said seat support being pivotally attached to said pair of pivoting elements.

24. The seat assembly of claim 23, wherein one of said pivoting elements engages a portion of the other of said pivoting elements when said seat support is pivoted to said lowered position to substantially secure said seat support and said seat portion at said lowered position.

25. The seat assembly of claim 23 including a biasing element that urges one of said pivoting elements downward relative to said base portion, and wherein downward pivotal movement of said one of said pivoting elements imparts an upward pivotal movement of said seat support toward said raised position.

26. The seat assembly of claim 21, wherein said seat support pivots through a fold angle between said raised position and said lowered position, said seat assembly being adjustable to adjust said fold angle of said seat support.

27. The seat assembly of claim 21, wherein said back rest support is adjustably mounted to said base portion, said back rest support being adjustable to adjust a tilt angle of said back rest support relative to said base portion.

28. The seat assembly of claim 21, wherein said seat assembly comprises an adjustable arm at each side of said seat assembly.
